(19) United States
(12) Patent Application Publication
(10) Pub. No.: US 2024/0123506 A1
(43) Pub. Date: Apr. 18, 2024

(54) SYSTEMS AND METHODS FOR PRINTING USING SUPERLUMINESCENT LIGHT

(71) Applicant: Georgia Tech Research Corporation, Atlanta, GA (US)

(72) Inventors: Sourabh Kumar Saha, Atlanta, GA (US); Jungho Choi, Atlanta, GA (US)

(21) Appl. No.: 18/377,060

(22) Filed: Oct. 5, 2023

Related U.S. Application Data
(60) Provisional application No. 63/414,076, filed on Oct. 7, 2022.

(51) Int. Cl. B22F 12/42; B22F 10/28; B22F 10/366; B22F 10/85; B22F 12/49; B22F 12/90; B29C 64/129; B29C 64/286; B33Y 10/00; B33Y 30/00; B33Y 50/02; C09D 11/037

(52) U.S. Cl. CPC B22F 12/42; B22F 10/28; B22F 10/366; B22F 10/85; B22F 12/49; B22F 12/90; B29C 64/129; B29C 64/286; B33Y 10/00; B33Y 30/00; B33Y 50/02; C09D 11/037; B29K 2033/08

(57) ABSTRACT

Disclosed herein are systems and methods of use thereof. For example, disclosed herein are systems and methods for printing using superluminescent light. For example, disclosed herein are methods of printing with superluminescent light, the methods comprising: generating a patterned light sheet from superluminescent light, with the proviso that the superluminescent light is not generated by a femtosecond laser; and projecting the patterned light sheet at an image plane onto or within a sample comprising a photosensitive material; thereby simultaneously illuminating a selected portion of the photosensitive material within a layer of the sample corresponding to a selected pattern, thereby causing a simultaneous photoreaction that prints structures in the selected pattern.

### CROSS-REFERENCE TO RELATED APPLICATIONS

This application claims the benefit of priority to U.S. Provisional Application No. 63/414,076 filed Oct. 7, 2022, which is hereby incorporated herein by reference in its entirety.

### BACKGROUND

Two-photon polymerization (TPP) enables printing of arbitrarily complex 3D structures with submicron features through nonlinear absorption of light. As nonlinear absorption occurs at high light intensities of ˜1 TW/cm², one requires femtosecond lasers that can generate such high intensities to implement TPP. In addition, conventional TPP is performed serially in a point-by-point manner Therefore, it is both slow and expensive to produce parts via TPP. In the past, the throughput challenge of TPP has been overcome by implementing a parallelized light projection technique. Although parallelization successfully increased the rate of printing by a thousand times, the excessive cost of the femtosecond laser is still a major challenge for manufacturing scalability.

Low-cost and high-throughput nanoscale patterning of metallic thin films is highly desirable for various applications but current fabrication techniques are either expensive or slow.

Less expensive and/or higher throughput systems and methods for printing and/or patterning various materials are needed. The systems and methods disclosed herein address these and other needs.

### SUMMARY

In accordance with the purposes of the disclosed compositions, methods, and systems as embodied and broadly described herein, the disclosed subject matter relates to systems and methods of use thereof. For example, disclosed herein are systems and methods for printing using superluminescent light.

For example, disclosed herein are systems for printing with superluminescent light, the system comprising: a light source for generating superluminescent light comprising a plurality of wavelengths, with the proviso that the light source is not a femtosecond laser; a tunable mask for receiving the superluminescent light, wherein the tunable mask comprises a dispersive element; the tunable mask being configured to receive the superluminescent light from the light source and spatially separate the plurality of wavelengths thereby splitting the superluminescent light into a plurality of light components, each of the plurality of light components comprising a portion of the plurality of wavelengths; an optical assembly configured to collimate the plurality of light components to create a collimated beam and to focus the collimated beam into a focused beam which is projected at an image plane onto or within a sample comprising a photosensitive material, such that the focused beam simultaneously illuminates a selected portion of the photosensitive material within a layer of the sample corresponding to a selected pattern, thereby causing a simultaneous photoreaction that prints structures in the selected pattern.

In some examples, the superluminescent light generated by the light source is spatially coherent and temporally incoherent.

In some examples, the instantaneous optical intensity of a focused beam of the superluminescent light does not exceed 1000 W/cm².

In some examples, the light source comprises a superluminescent light emitting diode (SLED).

In some examples, the tunable mask comprises a digital micromirror device.

In some examples, the system further comprises a controller operably coupled to the tunable mask.

In some examples, the optical assembly comprises a collimating lens and an objective lens, wherein the collimating lens is configured to collimate the plurality of light components to create a collimated beam and the objective lens is configured to focus the collimated beam into a focused beam, and wherein the distance between the tunable mask and the collimating lens is equal to the focal length of the collimating lens.

In some examples, the structures comprise a polymer, a metal, or a combination thereof.

In some examples, the system has a printing resolution (in plane) of from 100 nanometers to 100 micrometers.

In some examples, the system is configured to simultaneously illuminate the selected portion for an amount of time of from 1 millisecond to 10 minutes.

In some examples, the system is an additive manufacturing system configured to print 3D structures on a layer-by-layer basis.

Also disclosed herein are methods of use of any of the systems disclosed herein, for example the methods comprising using the system to print the structures.

Also disclosed herein are methods of printing with superluminescent light, the methods comprising: generating a patterned light sheet from superluminescent light, with the proviso that the superluminescent light is not generated by a femtosecond laser; and projecting the patterned light sheet at an image plane onto or within a sample comprising a photosensitive material; thereby simultaneously illuminating a selected portion of the photosensitive material within a layer of the sample corresponding to a selected pattern, thereby causing a simultaneous photoreaction that prints structures in the selected pattern.

In some examples, generating the patterned light sheet comprises: generating superluminescent light comprising a plurality of wavelengths, with the proviso that the superluminescent light is not generated by a femtosecond laser; directing the superluminescent light at a tunable mask, wherein the tunable mask comprises a dispersive element; wherein the tunable mask spatially separates the plurality of wavelengths thereby splitting the superluminescent light into a plurality of light components, each of the plurality of light components comprising a portion of the plurality of wavelengths; and directing at least a portion of the plurality of light components towards an optical assembly configured to collimate the plurality of light components to create a collimated beam and to focus the collimated beam into a focused beam which is projected at an image plane onto or within the sample as the patterned light sheet.

In some examples, the methods further comprise: receiving, by a processor, a first image having a plurality of pixels corresponding to the selected pattern; directing, by the processor, the generation of the superluminescent light; and directing, by the processor, based on the first image, the tunable mask to generate the patterned light sheet according to the selected pattern.

In some examples, the methods further comprise: supporting the sample on a motion stage; and controllably translocating the motion stage to thereby generate a continuous structure.

In some examples, the selected portion is illuminated for an amount of time of from 1 millisecond to 10 minutes.

In some examples, the methods further comprise developing the structure by exposure to a solvent.

In some examples, the structures comprise a metal and the method further comprises sintering and/or annealing the printed metal structures.

In some examples, the method has a printing resolution (in plane) of from 100 nanometers to 100 micrometers.

Additional advantages of the disclosed systems and methods will be set forth in part in the description which follows, and in part will be obvious from the description. The advantages of the disclosed systems and methods will be realized and attained by means of the elements and combinations particularly pointed out in the appended claims. It is to be understood that both the foregoing general description and the following detailed description are exemplary and explanatory only and are not restrictive of the disclosed compositions, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1: Upside-down optical projection system.

FIG. 2A Image of the projected light sheet corresponding to a bright illumination over a 30 μm×80 μm rectangular area—Illumination without grayscale compensation.

FIG. 2B: Image of the projected light sheet corresponding to a bright illumination over a 30 μm×80 μm rectangular area—Illumination with grayscale compensation.

FIG. 3A: SEM image of printed 2D pattern of STEAM LAB.

FIG. 3B: SEM image of printed 2D pattern of Georgia Institute of Technology logo.

FIG. 3C: SEM image of printed 2D pattern of the alphabet.

FIG. 4: Effect of SLED light exposure on the width of polymerized line features. No writing was observed for the projected linewidth of fewer than 5 pixels. Each data point has an error bar generated from 3 samples.

FIG. 5: SEM image of a printed polymer line feature with submicron line width.

FIG. 6A: SEM images of structures printed with grayscale compensation.

FIG. 6B: SEM images of structures printed without grayscale compensation.

FIG. 7: Schematic of the SLP system. L1 is a collimating lens, L2 is an objective lens, M1 is a mirror, M2 is a dichroic mirror, and BS is a 50:50 beam splitter. The LED provides the light for imaging whereas the SLED provides the superluminescent light for printing.

FIG. 8A: Schematic of the custom-built superluminescent light projection (SLP) system. L1 is a collimating lens, 2 is an objective lens, and the SLED is a superluminescent light emitting diode.

FIG. 8B: Nanoscale metal printing via superluminescent light projection (SLP). Digital bitmap image of an arbitrarily complex pattern (left) and a scanning electron microscope (SEM) image (right) of the metal pattern that was printed by projecting the image.

FIG. 9A: Exemplary silver nanostructures printed with superluminescent light projection. SEM image of the English alphabet. All structures were printed simultaneously by projecting one digital image per panel.

FIG. 9B: Exemplary silver nanostructure printed with superluminescent light projection. Magnified SEM image of the letter A from FIG. 9A.

FIG. 9C: Exemplary silver nanostructure printed with superluminescent light projection. Atomic force microscope (AFM) image of the letter A from FIG. 9A and FIG. 9B demonstrating sub-100 nm height.

FIG. 9D: Exemplary silver nanostructures printed with superluminescent light projection. SEM image of a printed USAF1951 test target pattern. All structures were printed simultaneously by projecting one digital image per panel.

FIG. 9E: Exemplary silver nanostructures printed with superluminescent light projection. SEM image of an array of printed nanowires. All structures were printed simultaneously by projecting one digital image per panel.

FIG. 9F: Magnified SEM image of a printed nanowire from FIG. 9E demonstrating submicron width.

FIG. 10A: Effect of thermal annealing on the printed nanowires. Electrical conductivity versus annealing time.

FIG. 10B: Effect of thermal annealing on the printed nanowires. Weight percentage of elements in the printed nanowires after various annealing times (0 min, 1 min, 2, min, and 3 min, left to right for each element). Data was obtained from EDS spectra. For each element, annealing time increases for bars from left to right.

FIG. 10C: SEM image of the nanowire after 0 min of annealing at 150° C. Scale bar is 200 nm long.

FIG. 10D: SEM image of the nanowire after 1 min of annealing at 150° C. Scale bar is 200 nm long.

FIG. 10E: SEM image of the nanowire after 2 min of annealing at 150° C. Scale bar is 200 nm long.

FIG. 10F: SEM image of the nanowire after 3 min of annealing at 150° C. Scale bar is 200 nm long.

FIG. 11A: Characterization of rate and resolution of printing. Effect of exposure time on the linewidth of the printed features for various projected linewidths. The optical power was 15 nW/pixel, as measured immediately before the objective lens. The error bars quantify the 1 SD in the linewidth as measured at five different points along the length of a nanowire.

FIG. 11B: SEM image of nanowire printed with 3-pixel wide line and an exposure of 500 ms. The optical power was 15 nW/pixel, as measured immediately before the objective lens.

FIG. 11C: SEM image of nanowire printed with 1-pixel wide line and an exposure of 2 s. The optical power was 15 nW/pixel, as measured immediately before the objective lens.

FIG. 12: Resolution (i.e., minimum printable feature size) versus areal rate of metal printing for superluminescent light projection and other techniques. P1-P6 are photoreduction-based techniques, whereas N1-N6 are non-photoreduction techniques. Literature references are: P1, S. K. Saha et al. Advanced Engineering Materials 2019, 21, 1900583; P2, S. Tabrizi et al. Advanced Optical Materials 2016, 4, 529; P3, A. Ishikawa et al. Journal of Laser Micro Nanoengineering 2012, 7, 11; P4, D. Qian et al. Optics letters 2018, 43, 5335; P5, L. Yang et al. Nature Communications 2023, 14, 1103; P6, Z. Zhao et al. Materials Today 2020, 37, 10; N1, B. W. An et al. Advanced Materials 2015, 27, 4322; N2, J. Schneider et al. Advanced Functional Materials 2016, 26, 833; N3, T. Takai et al. Opt. Express 2014, 22, 28109; N4, J. Hu et al. Science 2010, 329, 313; N5, L. Hirt et al. Advanced Materials 2016, 28, 2311; N6, R. Winkler et al. ACS Applied Nano Materials 2018, 1, 1014.

FIG. 13: Schematic of the optical system for superluminescent light projection. The digital micromirror device surface and the focal plane of the objective lens are conjugate planes in a 4f like arrangement between the collimating lens and the objective lens.

FIG. 14A: Pixel grid pattern projected on the digital micromirror device comprising a set of 5 lines, each 3-pixel wide, and at a period of 30 pixels.

FIG. 14B: Simulated intensity distribution in superluminescent light projection. Intensity distribution at the focal plane along the Y=0 line.

FIG. 14C: Simulated intensity distribution in superluminescent light projection. Intensity distribution on the focal plane represented as a surface plot. Each pixel on the digital micromirror device is demagnified to 170 nm in the projected image on the focal plane. The illumination optical power was 15 nW/pixel.

FIG. 14D: Simulated intensity distribution in superluminescent light projection. Intensity distribution on the focal plane represented as a 2D plot. Each pixel on the digital micromirror device is demagnified to 170 nm in the projected image on the focal plane. The illumination optical power was 15 nW/pixel.

FIG. 15: Simulated full-width half-max (FWHM) beam diameter and the peak intensity at the focal plane versus the width of the projected lines. The projected image comprises a set of 5 lines and at a period of 30 pixels. Each pixel on the digital micromirror device is demagnified to 170 nm in the projected image on the focal plane. The illumination optical power was 15 nW/pixel.

FIG. 16A: SEM image highlighting the locations on the nanowires where the EDS spectra were measured.

FIG. 16B: SEM image highlighting the locations on the nanowires where the EDS spectra were measured.

FIG. 17A: SEM image of the nanowire that was printed across large printed conductive pads.

FIG. 17B: AFM line scan across the width of the nanowire in FIG. 17A illustrating the height and width of the printed nanowire.

FIG. 18A: SEM image of discontinuous nanowires printed with 5-pixel wide lines at an exposure of 300 ms. Length of the nanowires are marked with arrows. Optical power for these experiments was 15 nW/pixel and the period of the lines was 50 pixels. Each pixel was demagnified to 170 nm in the projected image.

FIG. 18B: Magnified image of one of the nanowires in FIG. 18A. Width of the nanowire is marked with arrows.

FIG. 18C: SEM image of continuous nanowires printed with 5-pixel wide lines at an exposure of 800 ms. Optical power for these experiments was 15 nW/pixel and the period of the lines was 50 pixels. Each pixel was demagnified to 170 nm in the projected image.

FIG. 18D: Magnified image of one of the nanowires in FIG. 18C.

FIG. 19A. Photograph of silver ink solution.

FIG. 19B. Absorption spectra of the silver ink and the solution of DETC photoinitiator in ethanol.

FIG. 20: Nanoparticle size distribution corresponding to the structure shown in FIG. 9F. Sizes were measured by analyzing SEM image data using the ImageJ software tool.

FIG. 21: Schematic illustration of an example system as disclosed herein according to one implementation.

FIG. 22: Schematic illustration of an example system as disclosed herein according to one implementation.

FIG. 23: Schematic illustration of an example computing device.

### DETAILED DESCRIPTION

The compositions and methods described herein may be understood more readily by reference to the following detailed description of specific aspects of the disclosed subject matter and the Examples included therein.

Before the present systems and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%. It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity, and dimensionality. Examples of chemical properties include chemical composition.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning.

The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as feature or features) to an output (also known as target or target) during training with both labeled and unlabeled data.

Unless otherwise defined, all technical and scientific terms used herein have the same meaning as commonly understood by one of ordinary skill in the art to which this invention belongs.

### Systems

Light-based nanoscale printing systems and methods using pulsed femtosecond lasers are described, for example, in WO 2021/236907 which is incorporated herein for its description thereof. The systems and methods described herein use an alternate light source to provide a light-based printing system and method that eliminates the need for expensive and high-intensity lasers.

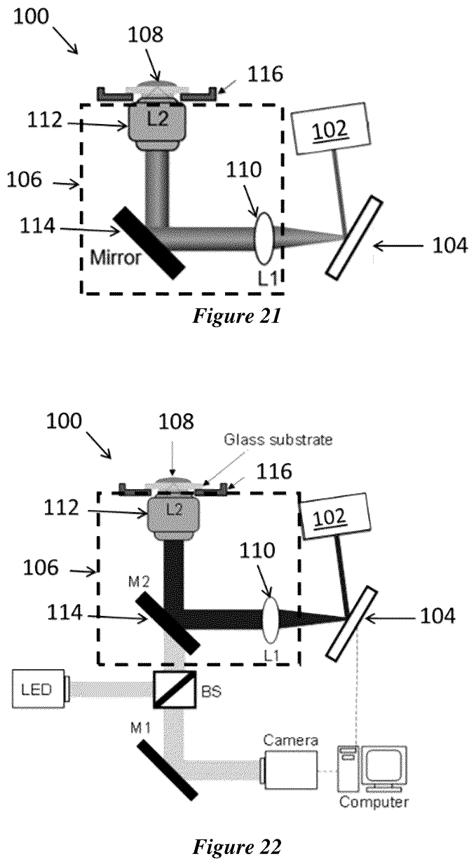

Referring now to FIG. 21-FIG. 22, described herein are systems 100 for printing with superluminescent light, for example, which has a much lower intensity than femtosecond lasers. In some examples, the systems 100 are for printing using projection of superluminescent light. The systems 100 comprise a light source 102 for generating superluminescent light comprising a plurality of wavelengths, with the proviso that the light source 102 is not a femtosecond laser. In some examples, the superluminescent light generated by the light source is spatially coherent but temporally incoherent. The systems 100 further comprise a tunable mask 104 for receiving the superluminescent light, wherein the tunable mask 104 comprises a dispersive element. The tunable mask 104 is configured to receive the superluminescent light from the light source 102 and spatially separate the plurality of wavelengths thereby splitting the superluminescent light into a plurality of light components, each of the plurality of light components comprising a portion of the plurality of wavelengths. The systems further comprise an optical assembly 106 configured to collimate the plurality of light components to create a collimated beam and to focus the collimated beam into a focused beam which is projected at an image plane onto or within a sample 108 comprising a photosensitive material, such that the focused beam simultaneously illuminates a selected portion of the photosensitive material within a layer of the sample 108 corresponding to a selected pattern, thereby causing a simultaneous photoreaction that prints structures in the selected pattern. In some examples, the system 100 is configured to print structures from a material through projection of patterned light sheets.

As used herein, “a selected portion” and “the selected portion” are meant to include any number of portions in any arrangement within the sample. Thus, for example “a selected portion” includes one or more selected portions. In some embodiments, the selected portion can comprise a plurality of selected portions.

The systems and methods described herein can simultaneously focus a collection of points (i.e., focus a “projected image”) in the interior of the sample without providing significant light intensity above or below the focused depth. Thus, this technique significantly increases the processing rate by parallelizing the generation of submicron features. It is important to note that with the apparatus and method described herein, the dosage at each individual focused spot may be independently tuned to generate arbitrarily complex patterns.

The sample comprises a photosensitive material. In some examples, the sample comprises the photosensitive material dispersed or dissolved in a solvent.

The printed structures can, for example, be a polymer, a metal, or a combination thereof.

In some examples, the photosensitive material comprises a photopolymer or a photoresist and the printed structures comprise a polymer.

In some examples, the sample comprises a metal ion that can be photoreduced to print structures comprising a metal. The metal can, for example, comprise Al, Ti, Cr, Mn, Fe, Co, Ni, Cu, Mo, Pd, Ag, Cd, Pt, Au, or a combination thereof. In some examples, the metal can comprise Ag, Au, Pt, or a combination thereof. In some examples, the metal comprises Ag.

The light source 102 can comprise any suitable light source, with the proviso that the light source 102 is not a femtosecond laser. In some examples, the light source 102 comprises a superluminescent light emitting diode (SLED). An example light source 102 is a continuous wave SLED which has a center wavelength of 405 nm, a 3 dB bandwidth of 4 nm, and a total spectral power of 36 mW. For example, the light source 102 can comprise a commercially available super-luminescent diode, such as a SLD405T from Thorlabs, USA.

The intensity and/or duration of illumination can be adjusted and/or selected such that the exposure dose meets a pre-defined threshold for the material. The parameters can, for example, be selected based on a dosage thresholding model, which captures the relevant physics of the printing process.

In some examples, the superluminescent light has an intensity of 1 Watt/cm² or more (e.g., 5 Watts/cm² or more, 10 Watts/cm² or more, 15 Watts/cm² or more, 20 Watts/cm² or more, 25 Watts/cm² or more, 30 Watts/cm² or more, 35 Watts/cm² or more, 40 Watts/cm² or more, 45 Watts/cm² or more, 50 Watts/cm² or more, 60 Watts/cm² or more, 70 Watts/cm² or more, 80 Watts/cm² or more, 90 Watts/cm² or more, 100 Watts/cm² or more, 125 Watts/cm² or more, 150 20 Watts/cm² or more, 175 Watts/cm² or more, 200 Watts/cm² or more, 225 Watts/cm² or more, 250 Watts/cm² or more, 300 Watts/cm² or more, 350 Watts/cm² or more, 400 Watts/cm² or more, 450 Watts/cm² or more, 500 Watts/cm² or more, 600 Watts/cm² or more, 700 Watts/cm² or more, 800 Watts/cm² or more, or 900 Watts/cm² or more). In some examples, the superluminescent light has an intensity of 1000 Watts/cm² or less (e.g., 900 Watts/cm² or less, 800 Watts/cm² or less, 700 Watts/cm² or less, 600 Watts/cm² or less, 500 Watts/cm² or less, 450

Watts/cm² or less, 400 Watts/cm² or less, 350 Watts/cm² or less, 300 Watts/cm² or less, 250 Watts/cm² or less, 225 Watts/cm² or less, 200 Watts/cm² or less, 175 Watts/cm² or less, 150 Watts/cm² or less, 125 Watts/cm² or less, 100 Watts/cm² or less, 90 Watts/cm² or less, 80 Watts/cm² or less, 70 Watts/cm² or less, 60 Watts/cm² or less, 50 Watts/cm² or less, 45 30 Watts/cm² or less, 40 Watts/cm² or less, 35 Watts/cm² or less, 30 Watts/cm² or less, 25 Watts/cm² or less, 20 Watts/cm² or less, 15 Watts/cm² or less, 10 Watts/cm² or less, or 5 Watts/cm² or less). The intensity of the superluminescent light can range from any of the minimum values described above to any of the maximum values described above. For example, the superluminescent light can have an intensity of from 1 to 1000 Watts/cm² (e.g., from 1 to 500 Watts/cm², from 500 to 1000 Watts/cm², from 1 to 200 Watts/cm², from 200 to 400 Watts/cm², from 400 to 600 Watts/cm², from 600 to 800 Watts/cm², from 800 to 1000 Watts/cm², from 1 to 900 Watts/cm², from 1 to 800 Watts/cm², from 1 to 700 Watts/cm², from 1 to 600 Watts/cm², from 1 to 400 Watts/cm², from 1 to 300 Watts/cm², or from 1 to 100 Watts/cm²). In some examples, the superluminescent light has an intensity of from 10 to 75 W/cm².

In some examples, the superluminescent light is low-intensity superluminescent light. In some examples, the instantaneous optical intensity of a focused beam of the superluminescent light does not exceed 1000 W/cm². For example, the instantaneous optical intensity of a focused beam of the superluminescent light is 1000 Watts/cm² or less (e.g., 900

Watts/cm² or less, 800 Watts/cm² or less, 700 Watts/cm² or less, 600 Watts/cm² or less, 500 Watts/cm² or less, 450 Watts/cm² or less, 400 Watts/cm² or less, 350 Watts/cm² or less, 300 Watts/cm² or less, 250 Watts/cm² or less, 225 Watts/cm² or less, 200 Watts/cm² or less, 175 Watts/cm² or less, 150 Watts/cm² or less, 125 Watts/cm² or less, 100 Watts/cm² or less, 90 Watts/cm² or less, 80 Watts/cm² or less, 70 Watts/cm² or less, 60 Watts/cm² or less, 50 Watts/cm² or less, 45 Watts/cm² or less, 40 Watts/cm² or less, 35 Watts/cm² or less, 30 Watts/cm² or less, 25 Watts/cm² or less, 20 Watts/cm² or less, 15 Watts/cm² or less, 10 Watts/cm² or less, or 5 Watts/cm² or less).

In some examples, the system 100 is configured to simultaneously illuminate the selected portion for an amount of time of 1 millisecond or more (e.g., 5 milliseconds or more, 10 milliseconds or more, 15 milliseconds or more, 20 milliseconds or more, 25 milliseconds or more, 30 milliseconds or more, 35 milliseconds or more, 40 milliseconds or more, 45 milliseconds or more, 50 milliseconds or more, 60 milliseconds or more, 70 milliseconds or more, 80 milliseconds or more, 90 milliseconds or more, 100 milliseconds or more, 125 milliseconds or more, 150 milliseconds or more, 175 milliseconds or more, 200 milliseconds or more, 225 milliseconds or more, 250 milliseconds or more, 300 milliseconds or more, 350 milliseconds or more, 400 milliseconds or more, 450 milliseconds or more, 500 milliseconds or more, 600 milliseconds or more, 700 milliseconds or more, 800 milliseconds or more, 900 milliseconds or more, 1 second or more, 2 seconds or more, 3 seconds or more, 4 seconds or 30 more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 1.25 minutes or more, 1.5 minutes or more, 1.75 minutes or more, 2 minutes or more, 2.25 minutes or more, 2.5 minutes or more, 3 minutes or more, 3.5 minutes or more, 4 minutes or more, 4.5 minutes or more, 5 minutes or more, 5.5 minutes or more, 6 minutes or more, 6.5 minutes or more, 7 minutes or more, 7.5 minutes or more, 8 minutes or more, 8.5 minutes or more, or 9 minutes or more). In some examples, the system 100 is configured to simultaneously illuminate the selected portion for an amount of time of 10 minutes or less (e.g., 9.5 minutes or less, 9 minutes or less, 8.5 minutes or less, 8 minutes or less, 7.5 minutes or less, 7 minutes or less, 6.5 minutes or less, 6 minutes or less, 5.5 minutes or less, 5 minutes or less, 4.5 minutes or less, 4 minutes or less, 3.5 minutes or less, 3 minutes or less, 2.5 minutes or less, 2.25 minutes or less, 2 minutes or less, 1.75 minutes or less, 1.5 minutes or less, 1.25 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 5 seconds or less, 4 seconds or less, 3 seconds or less, 2 seconds or less, 1 seconds or less, 900 milliseconds or less, 800 milliseconds or less, 700 milliseconds or less, 600 milliseconds or less, 500 milliseconds or less, 450 milliseconds or less, 400 milliseconds or less, 350 milliseconds or less, 300 milliseconds or less, 250 milliseconds or less, 225 milliseconds or less, 200 milliseconds or less, 175 milliseconds or less, 125 milliseconds or less, 100 milliseconds or less, 90 milliseconds or less, 80 milliseconds or less, 70 milliseconds or less, 60 milliseconds or less, 50 milliseconds or less, 45 milliseconds or less, 40 milliseconds or less, 35 milliseconds or less, 30 milliseconds or less, 25 milliseconds or less, 20 milliseconds or less, 15 milliseconds or less, 10 milliseconds or less, or 5 milliseconds or less). The amount of time for which the system 100 is configured to simultaneously illuminate the selected portion can range from any of the minimum values described above to any of the maximum values described above. For example, the system 100 can be configured to simultaneously illuminate the selected portion for an amount of time of from 1 millisecond to 10 minutes (e.g., from 1 millisecond to 5 minutes, from 5 minutes to 10 minutes, from 1 millisecond to 1 second, from 1 second to 1 minute, from 1 minute to 10 minutes, from 1 millisecond to 8 minutes, from 1 millisecond to 6 minutes, from 1 millisecond to 4 minutes, from 1 millisecond to 2 minutes, from 1 millisecond to 30 seconds, from 1 millisecond to 15 seconds, from 1 millisecond to 10 seconds, from 1 millisecond to 5 seconds, from 1 millisecond to 500 milliseconds, from 1 millisecond to 250 milliseconds, or from 1 millisecond to 100 milliseconds). In some examples, the system 100 is configured to simultaneously illuminate the selected portion for an amount of time of 10 seconds or less, 1 second or less, 500 milliseconds or less, 250 milliseconds or less, or 100 milliseconds or less.

The tunable mask 104 can comprise any suitable device, such as those known in the art. In some examples, the tunable mask 104 is a digital mask. In some examples, the tunable mask 104 comprises a digital micromirror device (DMD). Digital micro-mirror devices are commercially available from various manufacturers, for example Texas Instruments Inc. of Dallas, Tex. In some examples, the tunable mask 104 can be formed by a spatial light modulator (SLM). In some examples, the tunable mask 104 can comprise a strain-driven tunable diffraction grating such as those formed by wrinkling of supported thin films (e.g., U.S. Pat. No. 9,597,833, hereby incorporated by reference for its description thereof) or a fixed uniform or non-uniform grating mounted on a movable (rotating and/or translating) mount.

The tunable mask 104 comprises a dispersive optical element (e.g., one or more dispersive optical elements), i.e., it is capable of spatially separating the different optical frequencies (or wavelengths) of the incident beam. DMD, SLM, and tunable wrinkled films can all act as dispersive elements due to their periodic structure which diffracts light. When a light source is incident onto such a dispersive element, it diffracts and separates into multiple beams. The angular position of the diffracted beams is determined by the modes of diffraction. Each of these diffracted beams contains the full information about illuminated patterned subsections of the tunable mask in the form of individual beamlets that correspond to these subsections. These patterned subsections can correspond to individual mirrors in the DMD or individual peaks of a wrinkled grating wherein these subsections are themselves tunable. If the light source is a broadband source, such as a superluminescent light source, the beamlets (and the beams) emerging from the mask diverge instead of being in the form of a single beamlet or beam. This is because the angular position of the diffracted beamlets (and beams) is dependent on the specific wavelength. Tunability of the mask ensures that structures with various feature geometries can be printed. Further, arbitrary structures can be printed by loading a sequence of 2D images onto the mask.

With a DMD used as the tunable mask 104, each micro mirror of the DMD can be viewed as forming a pixel point. As such, the focused light sheet can comprise a 2D point cloud of focused spots wherein each focused spot corresponds to an ‘on’ point in the digital mask. Each micro mirror of the DMD can be viewed as forming a pixel point and each pixel point can be individually switched on or off. This is accomplished by rotating the mirror by a small angular amount between two predetermined positions (often ±12 degrees). In one predetermined position the pixel (i.e., micro mirror) forms an “on” state where the intensity of light emerging from the micro mirror pixel via reflection and diffraction along a particular set of directions is high whereas the other predetermined position forms an ‘off’ state where the intensity of the emergent light along the same set of directions is zero or a low value. Here, the cutoff for the qualitative terms ‘high’ and ‘low’ is determined by the specific downstream application. Often, commercially available DMD systems are designed so that the ratio of intensity for the off versus on state along a particular propagation direction is almost zero for incoherent light. This illumination tuning is sufficiently high to achieve two different exposure states (high exposure versus zero exposure). For the high exposure state, exposure of the sample is sufficient to print structures. For the low exposure state, the intensity is too low to print structures. The beamlets created from each of the “on” micro mirrors in the tunable mask 104 form a diverging beam and collectively form an image created using the tunable mask 104. Therefore, only the beamlets created from an “on” pixel within the tunable mask 104 are used to affect printing of material within the sample. The rest of the beamlets (i.e., all beamlets emerging from the ‘off’ pixels) can be re-directed into one or more light sinks. It is important to note that several diffracted beams emerge from the mask and each of these diffracted beams comprises the “on” beamlets. These beams differ in the angular position (diffracted mode) and energy (mode efficiency). For printing, it is preferable to use the beam from only that mode which has the highest diffraction efficiency (i.e., the highest energy). Other modes (beams) may be used for diagnostics or re-directed into light sinks. The optical assembly 106 can comprise any suitable components, such as known in the art. For example, the optical assembly 106 can comprise a lens, a mirror, a beam expander, a beam splitter, a beam homogenizer, a shutter, an aperture, a filter, a grating, etc., or a combination thereof.

In some examples, the optical assembly 106 comprises a lens (e.g., one or more lenses). The lens can be any type of lens, such as a simple lens, a compound lens, a spherical lens, a toric lens, a biconvex lens, a plano-convex lens, a plano-concave lens, a negative meniscus lens, a positive meniscus lens, a biconcave lens, a converging lens, a diverging lens, a cylindrical lens, a Fresnel lens, a lenticular lens, or a gradient index lens.

The optical assembly 106 can be configured to collimate the plurality of light components to create a collimated beam using any suitable components. For example, the optical assembly 106 can comprise one or more collimating optics configured to collimate the plurality of light components to create a collimated beam. The collimating optics can, for example, comprise a lens, a mirror, or a combination thereof.

The optical assembly 106 can be configured to focus the collimated beam into a focused beam using any suitable components. For example, the optical assembly 106 can comprise one or more focusing elements configured to focus the collimated beam into a focused beam. The focusing elements can, for example, comprise a lens, a mirror, or a combination thereof.

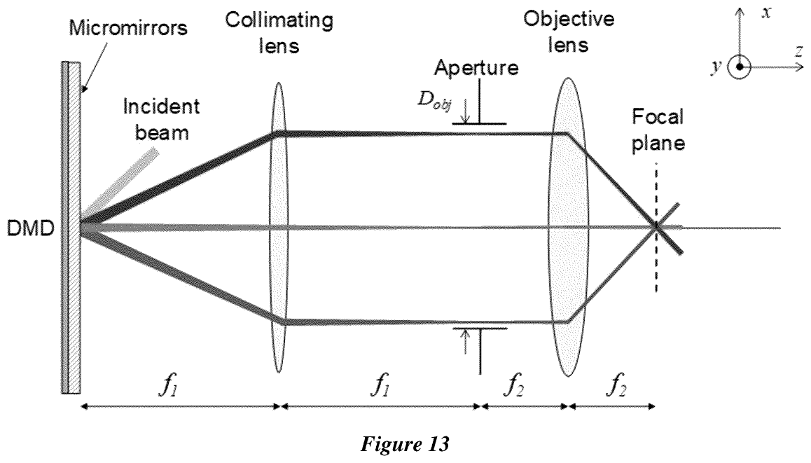

In some examples, the optical assembly 106 comprises a collimating lens 110 and an objective lens 112, wherein the collimating lens 110 is configured to collimate the plurality of light components to create a collimated beam and the objective lens 112 is configured to focus the collimated beam into a focused beam. An example objective lens 112 is a high numerical aperture (NA) oil immersion lens (such as a 40×1.3 NA lens). In some examples, the collimating lens 110 and the objective lens 112 have a 4f-like arrangement, for example as shown in FIG. 13. In this arrangement, the distance between the tunable mask 104 and the collimating lens 110 is equal to one focal length of the collimating lens 110.

In some examples, the optical assembly 106 can optionally further comprise one or more additional elements, such as a mirror 114. For example, the optical assembly 106 can further comprise a mirror 114 configured to receive the collimated beam from the collimating lens 110 and reflect the collimated beam towards the objective lens 112.

The focused beam is projected at an image plane onto or within a sample 108 comprising a photosensitive material. This focused image plane is the conjugate plane of the tunable mask 104. At the focused image plane on or within the sample 108, when the illumination is held for a finite duration of time, the exposure dosage at each point in the sample that corresponds to the “on” pixel in the tunable mask 104 is higher than the threshold dosage of the photosensitive material comprising the sample 108; whereas, the exposure dosage at each point in the sample corresponding to an “off” pixel is below the threshold exposure dosage. Thus, a pixelated image of the tunable mask 104 is formed in an X-Y plane within the sample 108. This enables an entire layer within the sample 108 to be written out in one operation, as the beamlets from “on” pixels are able to simultaneously write, in parallel, to a large plurality of points (i.e., on the order of 1×10⁶ or more) in one operation. Thus, the ability to form each layer of the sample 108 with a plurality of beamlets that write in parallel enables a dramatic reduction in the time needed to create a finished part from the sample 108.

In some examples, the system 100 can further comprise a means for supporting and translocating the sample, the optical assembly 106, or a combination thereof. In some examples, the system 100 further comprises a means for supporting and translocating the sample, wherein the means for supporting and translocating the sample comprises a motion stage 116, such as an X-Y-Z motion stage.

Three-dimensional structures can be fabricated by moving the focused image plane relative to the sample 108 using the motion stage 116. In actual practice, the motion of the motion stage 116 in the X-Y-Z plane can be controlled by an electronic control system. Alternatively, the motion stage 116 could be a fixedly supported stage (i.e., not movable) while the objective lens 112 is moved within a Z plane as needed. Still further, possibly both the motion stage 116 and the objective lens 112 could be moved simultaneously.

In some examples, the system 100 further comprises a controller operably coupled to the tunable mask 104. For example, the controller can comprise an electronic controller, which can, for example, comprise and/or be operably coupled to a computing device 1000. The controller can, for example, tune the tunable mask.

In some examples, the system 100 can include an electronic digital mask control system (not shown) that is operatively connected to the light source 102, tunable mask 104, objective lens 112, and motion stage 116. The electronic digital mask control system can, for example, comprise and/or be operably coupled to a computing device 1000.

Further, the focal plane of the objective lens 112 can be optically scanned in the axial Z (i.e., depth into the sample) direction using an electrically tunable lens (ETL). The ETL provides the ability to rapidly move the final focused image plane without any mechanical movement of the objective lens or the motion stage, thereby leading to an increase in rate by as much as a factor of 10. More complex part geometries can be generated by replacing the movable X-Y-Z stage with a 6-axis movable stage that is capable of motions along all six degrees of freedom (i.e., capable of X, Y, Z translations and tip, tilt, and rotation angular displacements).

The system 100 can be used to perform grayscale printing operation to which high-quality parts can be fabricated. The grayscale printing operation may include a sequence of operations and the selection of writing conditions in these operations that leads to a non-uniform “dosage” during printing within the same projected image plane. The term “dosage” refers to the combined effect of light intensity and duration of light exposure (in the form dosage=(intensity×time). Writing occurs at a point when the dosage at that point is above a threshold value (“threshold dosage”) for a given photosensitive material. For writing, a pixel must be continuously switched “on” for a duration of time that is longer than the threshold exposure time at the incident light intensity. Non-uniform dosage can be achieved by selectively switching some pixels on or off to selectively increase or decrease the dosage within the plane of the sample. In some embodiments, a series of patterns (i.e., map of pixel “on” and “off” states as shown herein) can be sent to the DMD and holding each of the patterns for finite durations of time. These pattern illumination durations would then be shorter than the maximum exposure time required for any spot within the field of projection. The net dosage at any point within the sample is the cumulative combined dosage from each projected image. Here, the field of projection refers to the maximum area of any focused image that can be projected onto/into the resist material. Thus, one may need to project a series of non-intuitive DMD patterns to print the desired structure at the focused plane through a process of sequentially projecting several DMD patterns and combining the effect of illumination intensity and duration of illumination.

It has also been experimentally observed that the threshold dosage depends on the proximity of features within the sample. There may be a minimum threshold exposure time required to affect printing in the sample when illuminated with specific peak intensity and for different feature spacings. In a sample part that contains closely spaced and sparsely spaced features, providing a uniform dosage may lead to over or under exposure-based defects. The grayscale dosage control of the grayscale printing operation may provide for non-uniform control of dosage in the same focused plane.

The grayscale printing operation is further described in the Examples herein below.

In some examples, the system 100 can further comprise an instrument configured to capture a signal from the tunable mask 104, the optical assembly 106, the sample, the structures, or a combination thereof. In some examples, the instrument can comprise a camera, an optical microscope, an electron microscope, a spectrometer, or a combination thereof. In some examples, the instrument comprises an imaging system.

The imaging system can include a separate illumination lamp but can share the same focusing elements as the processing system to generate an image of the processing plane on the camera to provide live imaging and recording of the printing process. To ensure that the optical sensing/visualization system does not interfere with the printing process, the wavelength of illumination in this system can be selected to lie outside the absorption spectrum of the resist material. In some examples, the instrument comprises an imaging system using an incoherent optical source.

Additional description of the system 100 can be found in U.S. Publication No. 2021/0001540 and WO 2021/236907, each of which are incorporated by reference herein in its entirety.

In some examples, the systems 100 are high resolution. As used herein, “resolution” refers to the smallest feature that can be printed with the system 100.

In some examples, the system 100 has a printing resolution (in plane) of 100 nanometers (nm) or more (e.g., 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 2 micrometers or more, 3 micrometers or more, 4 micrometers or more, 5 micrometers or more, 10 micrometers or more, 15 micrometers or more, 20 micrometers or more, 25 micrometers or more, 30 micrometers or more, 35 micrometers or more, 40 micrometers or more, 45 micrometers or more, 50 micrometers or more, 60 micrometers or more, 70 micrometers or more, 80 micrometers or more, or 90 micrometers or more). In some examples, the system 100 has a printing resolution (in plane) of 100 micrometers (microns, um) or less (e.g., 90 micrometers or less, 80 micrometers or less, 70 micrometers or less, 60 micrometers or less, 50 micrometers or less, 45 micrometers or less, 40 micrometers or less, 35 micrometers or less, 30 micrometers or less, 25 micrometers or less, 20 micrometers or less, 15 micrometers or less, 10 micrometers or less, 5 micrometers or less, 4 micrometers or less, 3 micrometers or less, 2 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, or 125 nanometers or less). The printing resolution (in plane) of the system 100 can range from any of the minimum values described above to any of the maximum values described above. For example, the system 100 can have a printing resolution (in plane) of from 100 nanometers to 100 micrometers (e.g., from 100 nanometers to 50 micrometers, from 50 micrometers to 100 micrometers, from 100 nanometers to 1 micrometer, from 1 micrometer to 10 micrometers, from 10 micrometers to 100 micrometers, from 100 nanometers to 75 micrometers, from 100 nanometers to 25 micrometers, from 100 nanometers to 10 micrometers, from 100 nanometers to 5 micrometers, from 100 nanometers to 750 nanometers, from 100 nanometers to 500 nanometers, or from 100 nanometers to 250 nanometers). In some examples, the system 100 has a printing resolution (in plane) of 1 micrometer or less, 500 nanometers (nm) or less, 360 nm or less, or 250 nm or less. In some examples, the system 100 has a nanoscale printing resolution (e.g., a printing resolution of 1 micrometer or less). In some examples, the system 100 has a sub-diffraction printing resolution.

In some examples, the system 100 is configured to print structures at a rate of 0.1 mm²/hour or more (e.g., 0.5 mm²/hour or more, 1 mm²/hour or more, 1.5 mm²/hour or more, 2 mm²/hour or more, 2.5 mm²/hour or more, 3 mm²/hour or more, 3.5 mm²/hour or more, 4 mm²/hour or more, 4.5 mm²/hour or more, 5 mm²/hour or more, 6 mm²/hour or more, 7 mm²/hour or more, 8 mm²/hour or more, 9 mm²/hour or more, 10 mm²/hour or more, 15 mm²/hour or more, 20 mm²/hour or more, 25 mm²/hour or more, 30 mm²/hour or more, 35 mm²/hour or more, 40 mm²/hour or more, 45 mm²/hour or more, 50 mm²/hour or more, 60 mm²/hour or more, 70 mm²/hour or more, 80 mm²/hour or more, or 90 mm²/hour or more). In some examples, the system 100 is configured to print structures at a rate of 100 mm²/hour or less (e.g., 90 mm²/hour or less, 80 mm²/hour or less, 70 mm²/hour or less, 60 mm²/hour or less, 50 mm²/hour or less, 45 mm²/hour or less, 40 mm²/hour or less, 35 mm²/hour or less, 30 mm²/hour or less, 25 mm²/hour or less, 20 mm²/hour or less, 15 mm²/hour or less, 10 mm²/hour or less, 9 mm²/hour or less, 8 mm²/hour or less, 7 mm²/hour or less, 6 mm²/hour or less, 5 mm²/hour or less, 4.5 mm²/hour or less, 4 mm²/hour or less, 3.5 mm²/hour or less, 3 mm²/hour or less, 2.5 mm²/hour or less, 2 mm²/hour or less, 1.5 mm²/hour or less, 1 mm²/hour or less, or 0.5 mm²/hour or less). The rate at which the system 100 is configured to print structure can range from any of the minimum values described above to any of the maximum values described above. For example, the system 100 can be configured to print structures at a rate of from 0.1 to 100 mm²/hour (e.g., from 0.1 to 50 mm²/hr, from 50 to 100 mm²/hr, from 0.1 to 20 mm²/hr, from 20 to 40 mm²/hr, from 40 to 60 mm²/hr, from 60 to 80 mm²/hr, from 80 to 100 mm²/hr, from 0.5 to 100 mm²/hr, from 1 to 100 mm²/hr, from 10 to 100 mm²/hr, from 15 to 100 mm²/hr, or from 25 to 100 mm²/hr). In some examples, the system 100 is configured to print structures at a rate of 0.1 mm²/hour or more, 1 mm²/hr or more, 10 mm²/hr or more, or 15 mm²/hr or more.

In some examples, the system 100 is an additive manufacturing system 100 configured to print 3D structures on a layer-by-layer basis. In the layer-by-layer technique, the motion stage is moved along the depth direction after printing of a layer and the projection is performed again to print the new layer.

### Methods

Also disclosed herein are methods of use of any of the systems 100 disclosed herein, the methods comprising using the system 100 to print the structures.

Also disclosed herein are methods of printing with superluminescent light (e.g., methods of printing using projection of superluminescent light), the methods comprising: generating a patterned light sheet from superluminescent light, with the proviso that the superluminescent light is not generated by a femtosecond laser; and projecting the patterned light sheet at an image plane onto or within a sample comprising a photosensitive material; thereby simultaneously illuminating a selected portion of the photosensitive material within a layer of the sample corresponding to a selected pattern, thereby causing a simultaneous photoreaction that prints structures in the selected pattern.

In some examples, generating the patterned light sheet comprises generating superluminescent light comprising a plurality of wavelengths, with the proviso that the superluminescent light is not generated by a femtosecond laser; directing the super-luminescent light at a tunable mask , wherein the tunable mask comprises a dispersive element; wherein the tunable mask spatially separates the plurality of wavelengths thereby splitting the superluminescent light into a plurality of light components, each of the plurality of light components comprising a portion of the plurality of wavelengths; and directing at least a portion of the plurality of light components towards an optical assembly configured to collimate the plurality of light components to create a collimated beam and to focus the collimated beam into a focused beam which is projected at an image plane onto or within the sample as the patterned light sheet.

In some examples, the methods further comprise receiving, by a processor, a first image having a plurality of pixels corresponding to the selected pattern; directing, by the processor, the generation of the superluminescent light; and directing, by the processor, based on the first image, the tunable mask to generate the patterned light sheet according to the selected pattern.

In some examples, the methods further comprise supporting the sample on a motion stage; and controllably translocating the motion stage to thereby generate a continuous structure.

In some examples, the methods further comprise developing the structure by exposure to a solvent.

The sample comprises a photosensitive material. In some examples, the sample comprises the photosensitive material dispersed or dissolved in a solvent.

The printed structures can, for example, be a polymer, a metal, or a combination thereof.

In some examples, the photosensitive material comprises a photopolymer or a photoresist and the printed structures comprise a polymer.

In some examples, the sample comprises a metal ion that can be photoreduced to print structures comprising a metal. The metal can, for example, comprise Al, Ti, Cr, Mn, Fe, Co, Ni, Cu, Mo, Pd, Ag, Cd, Pt, Au, or a combination thereof. In some examples, the metal can comprise Ag, Au, Pt, or a combination thereof. In some examples, the metal comprises Ag.

In some examples, the structures comprise a metal and the methods further comprise sintering and/or annealing the printed metal structures.

The intensity and/or duration of illumination can be adjusted and/or selected such that the exposure dose meets a pre-defined threshold for the material. The parameters can, for example, be selected based on a dosage thresholding model, which captures the relevant physics of the printing process.

In some examples, the superluminescent light has an intensity of 1 Watt/cm² or more (e.g., 5 Watts/cm² or more, 10 Watts/cm² or more, 15 Watts/cm² or more, 20 Watts/cm² or more, 25 Watts/cm² or more, 30 Watts/cm² or more, 35 Watts/cm² or more, 40 Watts/cm² or more, 45 Watts/cm² or more, 50 Watts/cm² or more, 60 Watts/cm² or more, 70 Watts/cm² or more, 80 Watts/cm² or more, 90 Watts/cm² or more, 100 Watts/cm² or more, 125 Watts/cm² or more, 150Watts/cm² or more, 175 Watts/cm² or more, 200 Watts/cm² or more, 225 Watts/cm² or more, 250 Watts/cm² or more, 300 Watts/cm² or more, 350 Watts/cm² or more, 400 Watts/cm² or more, 450 Watts/cm² or more, 500 Watts/cm² or more, 600 Watts/cm² or more, 700 Watts/cm² or more, 800 Watts/cm² or more, or 900 Watts/cm² or more). In some examples, the superluminescent light has an intensity of 1000 Watts/cm² or less (e.g., 900 Watts/cm² or less, 800 Watts/cm² or less, 700 Watts/cm² or less, 600 Watts/cm² or less, 500 Watts/cm² or less, 450 Watts/cm² or less, 400 Watts/cm² or less, 350 Watts/cm² or less, 300 Watts/cm² or less, 250 Watts/cm² or less, 225 Watts/cm² or less, 200 Watts/cm² or less, 175 Watts/cm² or less, 150 Watts/cm² or less, 125 Watts/cm² or less, 100 Watts/cm² or less, 90 Watts/cm² or less, 80 Watts/cm² or less, 70 Watts/cm² or less, 60 Watts/cm² or less, 50 Watts/cm² or less, 45 Watts/cm² or less, 40 Watts/cm² or less, 35 Watts/cm² or less, 30 Watts/cm² or less, 25 Watts/cm² or less, 20 Watts/cm² or less, 15 Watts/cm² or less, 10 Watts/cm² or less, or 5 Watts/cm² or less). The intensity of the superluminescent light can range from any of the minimum values described above to any of the maximum values described above. For example, the superluminescent light can have an intensity of from 1 to 1000 Watts/cm² (e.g., from 1 to 500 Watts/cm², from 500 to 1000 Watts/cm², from 1 to 200 Watts/cm², from 200 to 400 Watts/cm², from 400 to 600 Watts/cm², from 600 to 800 Watts/cm², from 800 to 1000 Watts/cm², from 1 to 900 Watts/cm², from 1 to 800 Watts/cm², from 1 to 700 Watts/cm², from 1 to 600 Watts/cm², from 1 to 400 Watts/cm², from 1 to 300 Watts/cm², or from 1 to 100 Watts/cm 2). In some examples, the superluminescent light has an intensity of from 10 to 75 W/cm².

In some examples, the superluminescent light is low-intensity superluminescent light.

In some examples, the instantaneous optical intensity of a focused beam of the superluminescent light does not exceed 1000 W/cm². For example, the instantaneous optical intensity of a focused beam of the superluminescent light is 1000 Watts/cm² or less (e.g., 900 Watts/cm² or less, 800 Watts/cm² or less, 700 Watts/cm² or less, 600 Watts/cm² or less, 500 Watts/cm² or less, 450 Watts/cm² or less, 400 Watts/cm² or less, 350 Watts/cm² or less, 300 Watts/cm² or less, 250 Watts/cm² or less, 225 Watts/cm² or less, 200 Watts/cm² or less, 175 Watts/cm² or less, 150 Watts/cm² or less, 125 Watts/cm² or less, 100 Watts/cm² or less, 90 Watts/cm² or less, 80 Watts/cm² or less, 70 Watts/cm² or less, 60 Watts/cm² or less, 50 Watts/cm² or less, 45 Watts/cm² or less, 40 Watts/cm² or less, 35 Watts/cm² or less, 30 Watts/cm² or less, 25 Watts/cm² or less, 20 Watts/cm² or less, 15 Watts/cm² or less, 10 Watts/cm² or less, or 5 Watts/cm² or less).

In some examples, the selected portion is simultaneously illuminated for an amount of time of 1 millisecond or more (e.g., 5 milliseconds or more, 10 milliseconds or more, 15 milliseconds or more, 20 milliseconds or more, 25 milliseconds or more, 30 milliseconds or more, 35 milliseconds or more, 40 milliseconds or more, 45 milliseconds or more, 50 milliseconds or more, 60 milliseconds or more, 70 milliseconds or more, 80 milliseconds or more, 90 milliseconds or more, 100 milliseconds or more, 125 milliseconds or more, 150 milliseconds or more, 175 milliseconds or more, 200 milliseconds or more, 225 milliseconds or more, 250 milliseconds or more, 300 milliseconds or more, 350 milliseconds or more, 400 milliseconds or more, 450 milliseconds or more, 500 milliseconds or more, 600 milliseconds or more, 700 milliseconds or more, 800 milliseconds or more, 900 milliseconds or more, 1 second or more, 2 seconds or more, 3 seconds or more, 4 seconds or more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 1.25 minutes or more, 1.5 minutes or more, 1.75 minutes or more, 2 minutes or more, 2.25 minutes or more, 2.5 minutes or more, 3 minutes or more, 3.5 minutes or more, 4 minutes or more, 4.5 minutes or more, 5 minutes or more, 5.5 minutes or more, 6 minutes or more, 6.5 minutes or more, 7 minutes or more, 7.5 minutes or more, 8 minutes or more, 8.5 minutes or more, or 9 minutes or more). In some examples, the selected portion is simultaneously illuminated for an amount of time of 10 minutes or less (e.g., 9.5 minutes or less, 9 minutes or less, 8.5 minutes or less, 8 minutes or less, 7.5 minutes or less, 7 minutes or less, 6.5 minutes or less, 6 minutes or less, 5.5 minutes or less, 5 minutes or less, 4.5 minutes or less, 4 minutes or less, 3.5 minutes or less, 3 minutes or less, 2.5 minutes or less, 2.25 minutes or less, 2 minutes or less, 1.75 minutes or less, 1.5 minutes or less, 1.25 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 5 seconds or less, 4 seconds or less, 3 seconds or less, 2 seconds or less, 1 seconds or less, 900 milliseconds or less, 800 milliseconds or less, 700 milliseconds or less, 600 milliseconds or less, 500 milliseconds or less, 450 milliseconds or less, 400 milliseconds or less, 350 milliseconds or less, 300 milliseconds or less, 250 milliseconds or less, 225 milliseconds or less, 200 milliseconds or less, 175 milliseconds or less, 125 milliseconds or less, 100 milliseconds or less, 90 milliseconds or less, 80 milliseconds or less, 70 milliseconds or less, 60 milliseconds or less, 50 milliseconds or less, 45 milliseconds or less, 40 milliseconds or less, 35 milliseconds or less, 30 milliseconds or less, 25 milliseconds or less, 20 milliseconds or less, 15 milliseconds or less, 10 milliseconds or less, or 5 milliseconds or less). The amount of time for which the selected portion is simultaneously illuminated can range from any of the minimum values described above to any of the maximum values described above. For example, the selected portion can be simultaneously illuminated for an amount of time of from 1 millisecond to 10 minutes (e.g., from 1 millisecond to 5 minutes, from 5 minutes to 10 minutes, from 1 millisecond to 1 second, from 1 second to 1 minute, from 1 minute to 10 minutes, from 1 millisecond to 8 minutes, from 1 millisecond to 6 minutes, from 1 millisecond to 4 minutes, from 1 millisecond to 2 minutes, from 1 millisecond to 30 seconds, from 1 millisecond to 15 seconds, from 1 millisecond to 10 seconds, from 1 millisecond to 5 seconds, from 1 millisecond to 500 milliseconds, from 1 millisecond to 250 milliseconds, or from 1 millisecond to 100 milliseconds). In some examples, the selected portion is simultaneously illuminated for an amount of time of 10 seconds or less, 1 second or less, 500 milliseconds or less, 250 milliseconds or less, or 100 milliseconds or less.

In some examples, the methods have a printing resolution (in plane) of 100 nanometers (nm) or more (e.g., 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 2 micrometers or more, 3 micrometers or more, 4 micrometers or more, 5 micrometers or more, 10 micrometers or more, 15 micrometers or more, 20 micrometers or more, 25 micrometers or more, 30 micrometers or more, 35 micrometers or more, 40 micrometers or more, 45 micrometers or more, 50 micrometers or more, 60 micrometers or more, 70 micrometers or more, 80 micrometers or more, or 90 micrometers or more). In some examples, the methods have a printing resolution (in plane) of 100 micrometers (microns, μm) or less (e.g., 90 micrometers or less, 80 micrometers or less, 70 micrometers or less, 60 micrometers or less, 50 micrometers or less, 45 micrometers or less, 40 micrometers or less, 35 micrometers or less, 30 micrometers or less, 25 micrometers or less, 20 micrometers or less, 15 micrometers or less, 10 micrometers or less, 5 micrometers or less, 4 micrometers or less, 3 micrometers or less, 2 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, or 125 nanometers or less). The printing resolution (in plane) of the methods can range from any of the minimum values described above to any of the maximum values described above. For example, the methods can have a printing resolution (in plane) of from 100 nanometers to 100 micrometers (e.g., from 100 nanometers to 50 micrometers, from 50 micrometers to 100 micrometers, from 100 nanometers to 1 micrometer, from 1 micrometer to 10 micrometers, from 10 micrometers to 100 micrometers, from 100 nanometers to 75 micrometers, from 100 nanometers to 25 micrometers, from 100 nanometers to 10 micrometers, from 100 nanometers to 5 micrometers, from 100 nanometers to 750 nanometers, from 100 nanometers to 500 nanometers, or from 100 nanometers to 250 nanometers). In some examples, the methods have a printing resolution (in plane) of 1 micrometer or less, 500 nanometers (nm) or less, 360 nm or less, or 250 nm or less. In some examples, the methods have a nanoscale printing resolution (e.g., a printing resolution of 1 micrometer or less). In some examples, the methods have a sub-diffraction printing resolution.

In some examples, the methods print structures at a rate of 0.1 mm²/hour or more (e.g., 0.5 mm²/hour or more, 1 mm²/hour or more, 1.5 mm²/hour or more, 2 mm²/hour or more, 2.5 mm²/hour or more, 3 mm²/hour or more, 3.5 mm²/hour or more, 4 mm²/hour or more, 4.5 mm²/hour or more, 5 mm²/hour or more, 6 mm²/hour or more, 7 mm²/hour or more, 8 mm²/hour or more, 9 mm²/hour or more, 10 mm²/hour or more, 15 mm²/hour or more, 20 mm²/hour or more, 25 mm²/hour or more, 30 mm²/hour or more, 35 mm²/hour or more, 40 mm²/hour or more, 45 mm²/hour or more, 50 mm²/hour or more, 60 mm²/hour or more, 70 mm²/hour or more, 80 mm²/hour or more, or 90 mm²/hour or more). In some examples, the methods print structures at a rate of 100 mm²/hour or less (e.g., 90 mm²/hour or less, 80 mm²/hour or less, 70 mm²/hour or less, 60 mm²/hour or less, 50 mm²/hour or less, 45 mm²/hour or less, 40 mm²/hour or less, 35 mm²/hour or less, 30 mm²/hour or less, 25 mm²/hour or less, 20 mm²/hour or less, 15 mm²/hour or less, 10 mm²/hour or less, 9 mm²/hour or less, 8 mm²/hour or less, 7 mm²/hour or less, 6 mm²/hour or less, 5 mm²/hour or less, 4.5 mm²/hour or less, 4 mm²/hour or less, 3.5 mm²/hour or less, 3 mm²/hour or less, 2.5 mm²/hour or less, 2 mm²/hour or less, 1.5 mm²/hour or less, 1 mm²/hour or less, or 0.5 mm²/hour or less). The rate at which the methods print structure can range from any of the minimum values described above to any of the maximum values described above. For example, the methods can print structures at a rate of from 0.1 to 100 mm²/hour (e.g., from 0.1 to 50 mm²/hr, from 50 to 100 mm²/hr, from 0.1 to 20 mm²/hr, from 20 to 40 mm²/hr, from 40 to 60 mm²/hr, from 60 to 80 mm²/hr, from 80 to 100 mm²/hr, from 0.5 to 100 mm²/hr, from 1 to 100 mm²/hr, from 10 to 100 mm²/hr, from 15 to 100 mm²/hr, or from 25 to 100 mm²/hr). In some examples, the methods print structures at a rate of 0.1 mm²/hour or more, 1 mm²/hr or more, 10 mm²/hr or more, or 15 mm²/hr or more.

In some examples, the methods comprise additive manufacturing that prints 3D structures on a layer-by-layer basis. In the layer-by-layer technique, the motion stage is moved along the depth direction after printing of a layer and the projection is performed again to print the new layer.

Also disclosed herein are articles of manufacture comprising the structures printed using any of the systems or methods described herein. In some examples, the article comprises an optical or photonic device, a quantum device, a light directing chip, a LIDAR component, a microfluid device, a microrobotic device, an electronic device, a battery or energy storage device.

### Computing Device

The systems 100 can, in some examples, comprise a computing device.

Any of the methods disclosed herein can be carried out in whole or in part on one or more computing or processing devices.

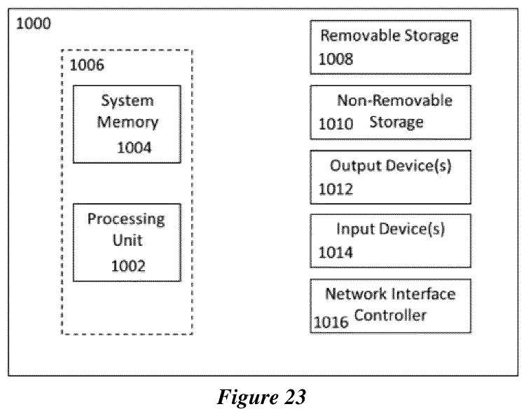

FIG. 23 illustrates an example computing device 1000 upon which examples disclosed herein may be implemented. The computing device 1000 can include a bus or other communication mechanism for communicating information among various components of the computing device 1000. In its most basic configuration, computing device 1000 typically includes at least one processing unit 1002 (a processor) and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 23 by a dashed line 1006. The processing unit 1002 may be a standard programmable processor that performs arithmetic and logic operations necessary for operation of the computing device 1000.

The computing device 1000 can have additional features/functionality. For example, computing device 1000 may include additional storage such as removable storage 1008 and non-removable storage 1010 including, but not limited to, magnetic or optical disks or tapes. The computing device 1000 can also contain network connection(s) 1016 that allow the device to communicate with other devices. The computing device 1000 can also have input device(s) 1014 such as a keyboard, mouse, touch screen, antenna or other systems configured to communicate with the camera in the system described above, etc. Output device(s) 1012 such as a display, speakers, printer, etc. may also be included. The additional devices can be connected to the bus in order to facilitate communication of data among the components of the computing device 1000.

The processing unit 1002 can be configured to execute program code encoded in tangible, computer-readable media. Computer-readable media refers to any media that is capable of providing data that causes the computing device 1000 (i.e., a machine) to operate in a particular fashion. Various computer-readable media can be utilized to provide instructions to the processing unit 1002 for execution. Common forms of computer-readable media include, for example, magnetic media, optical media, physical media, memory chips or cartridges, a carrier wave, or any other medium from which a computer can read. Example computer-readable media can include, but is not limited to, volatile media, non-volatile media, and transmission media. Volatile and non-volatile media can be implemented in any method or technology for storage of information such as computer readable instructions, data structures, program modules or other data and common forms are discussed in detail below. Transmission media can include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1002 can execute program code stored in the system memory 1004. For example, the bus can carry data to the system memory 1004, from which the processing unit 1002 receives and executes instructions. The data received by the system memory 1004 can optionally be stored on the removable storage 1008 or the non-removable storage 1010 before or after execution by the processing unit 1002.

The computing device 1000 typically includes a variety of computer-readable media. Computer-readable media can be any available media that can be accessed by device 1000 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media can be part of computing device 1000.

It should be understood that the various techniques described herein can be implemented in connection with hardware or software or, where appropriate, with a combination thereof. Thus, the methods, systems, and associated signal processing of the presently disclosed subject matter, or certain aspects or portions thereof, can take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs can implement or utilize the processes described in connection with the presently disclosed subject matter, e.g., through the use of an application programming interface (API), reusable controls, or the like. Such programs can be implemented in a high level procedural or object-oriented programming language to communicate with a computer system. However, the program(s) can be implemented in assembly or machine language, if desired. In any case, the language can be a compiled or interpreted language and it may be combined with hardware implementations.

In certain examples, the methods can be carried out in whole or in part on a computing device 1000 comprising a processor 1002 and a memory 1004 operably coupled to the processor 1002, the memory 1004 having further computer-executable instructions stored thereon that, when executed by the processor 1002, cause the processor 1002 to carry out one or more of the method steps described above.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

### Example Systems and Methods

Disclosed herein are systems and methods for nanoscale printing using low-intensity light.

Light-based nanoscale printing often requires expensive high-intensity laser sources, such as pulsed femtosecond lasers, to achieve fine nanoscale resolution. This need for expensive lasers makes nanoscale printing unaffordable for many potential end users. Here, an alternate light-based printing system and method is disclosed that eliminates the need for expensive lasers while simultaneously achieving fine nanoscale printing of polymers and metals. In the disclosed technique, the projection of superluminescent light is applied to achieve fine nanoscale printing at high rates. The system comprises a low-cost superluminescent light source, a digital mask, an optical projection mechanism, and a motion stage that can be used to print structures through projection of patterned light sheets. Light sheets can be patterned into arbitrary two-dimensional (2D) shapes with features smaller than 250 nm by using the digital mask. 3D structures can be printed through a layer-by-layer stacking mechanism. This invention can therefore significantly reduce the overall cost of nanoscale printing by 10-50 times and make it accessible to a wider userbase.

Light-based nanoscale printing systems and methods using pulsed femtosecond lasers are described, for example, in WO 2021/236907 which is incorporated herein for its description thereof. The systems and methods described herein use an alternate light source to provide a light-based printing system and method that eliminates the need for expensive lasers while simultaneously achieving fine nanoscale printing of polymers and metals. For example, the systems and methods disclosed herein can be configured for low intensity operation.

Disclosed herein are systems for nanoscale printing using low-intensity light. In some examples, the system uses projection of superluminescent light. In some examples, the system comprises: a superluminescent light source, a digital mask, an optical projection mechanism, and a motion stage, wherein the system is configured to print structures from a material through projection of patterned light sheets. In some examples, the superluminescent light source comprises a superluminescent light emitting diode (SLED). In some examples, the system is configured to additive manufacturing of 3D structures on a layer-by-layer basis. In some examples, the material printed comprises a polymer, a metal, or a combination thereof.

Also disclosed herein are methods of nanoscale printing using any of the systems disclosed here.

Also disclosed herein are articles of manufacture made by any of the methods disclosed herein. In some examples, the article comprises an optical or photonic device, a quantum device, a light directing chip, a LIDAR component, a microfluid device, a microrobotic device, an electronic device, a battery or energy storage device.

Applications include, but are not limited to: Micro-optics for quantum devices, Meta-photonics for flat optics and photonic quantum devices, Printed structures for light directing chips (LIDAR in self-driving cars), Micro-fluidics chips and micro-robots for biomedical and drug delivery applications, Printed electronics, and 3D printed batteries.

Advantages can include, but are not limited to: reduced cost of printer (for nanoscale printing) by 10-50 times without compromising speed or resolution, ability to print finer features, increased speed of printing (e.g., by 1000 times in some instances), improved resolution (e.g., from micron scale to nanometer scale), and larger variety of printable materials.

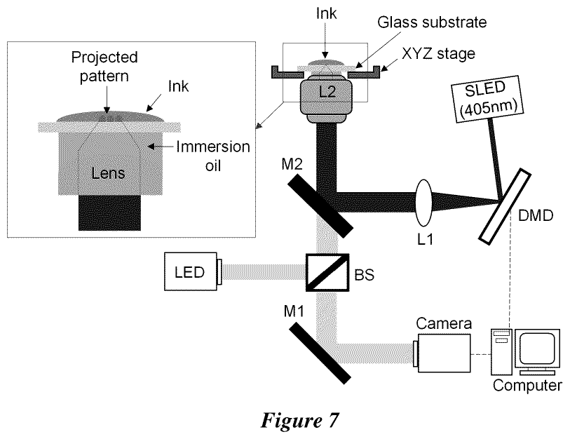

A schematic of an example superluminescent light projection (SLP) system is illustrated in FIG. 7. The system comprises an upside-down printer in which patterned images are projected at the interface of the glass substrate and the ink solution Images are projected off of a commercially available digital micromirror device (DMD) which acts as a digital mask to pattern the light beam into dark and bright regions. This is achieved by switching the individual micromirrors (i.e., pixels) on the DMD as either off or on. When a micromirror is switched on, the incident light is reflected toward a collimating lens whereas when it is switched off the incident light is reflected out of the system into a beam stop. Thus, a pixelated intensity profile is generated at the DMD corresponding to the image that is loaded on it.

The DMD is illuminated by superluminescent blue light generated from a SLED. The superluminescent light is a continuous wave, it has a center wavelength of 405 nm, a 3dB bandwidth of 4 nm and a total spectral power of 36 mW. A 4f-like arrangement of the collimating lens and the objective lens is set up to generate a demagnified image of the illuminated surface of the DMD on the focal plane of the objective lens. In the printer, the pixel pitch on the DMD is demagnified to a length of 171 nm in the projected image at the focal plane. The glass substrate is positioned on an automated X-Y-Z motion stage such that the interface between the glass substrate and the ink lies at the focal plane of the objective lens. Here, a high numerical aperture (NA) oil immersion objective lens (40×1.3 NA) was used to achieve fine submicron scale diffraction-limited focused spots. Therefore, the region between the lens and the substrate is filled with oil immersion medium to minimize spherical aberrations. In-situ optical imaging of the printing process is performed with a camera that collects the light generated by a diode after it reflects off of the substrate. The wavelength of this imaging beam (554 nm) was selected to minimize light absorption by the ink.

The optical layout in the SLP system is similar to the one in a past demonstration of projection of patterned femtosecond (fs) light sheets (Saha S K et al. Science, 2019, 366, 105-9; WO 2021/236907). Both techniques use multispectral light that is spatially coherent but temporally incoherent. The different wavelengths of the SLED light emerge at slightly different angles from the DMD due to the diffraction grating-like effect of the periodic micromirror pattern on the DMD. The 4f-like arrangement of the two lenses ensures that the various wavelengths are collected and recombined within a short region around the focal plane of the objective. The spectral separation-and-recombination generates a strong intensity gradient along the depth direction at the focal plane and the spectral coherence ensures strong intensity contrast within the focal plane. This effect was been leveraged here to generate fine nanoscale printed features. The SLP technique is therefore capable of patterning arbitrary structures with submicron in-plane resolution.

### Example 2

### Low-Cost and High Throughput Printing of Polymeric Nanostructures Via Projection of Superluminescent Light

Abstract. Light-directed additive manufacturing of submicron scale structures often requires expensive light sources such as femtosecond pulsed lasers for two photon absorption. However, mass production through this technique is challenging due to the high production cost and low production rate. Herein, the feasibility of achieving submicron scale printing by replacing expensive femtosecond lasers with low cost commercially available superluminescent light emitting diode (SLED) is examined Here, the ability to print arbitrarily complex submicron scale 2D structures with features as small as 250 nm were demonstrated using SLED light sources that are a hundred times less expensive than femtosecond lasers.

Introduction. Two-photon polymerization (TPP) enables printing of arbitrarily complex 3D structures with submicron features through nonlinear absorption of light. As nonlinear absorption occurs at high light intensities of ˜1 TW/cm², one requires femtosecond lasers that can generate such high intensities to implement TPP (Lee K S et al. Progress in Polymer Science, 2008, 33(6), 631-681). In addition, conventional TPP is performed serially in a point-by-point manner Therefore, it is both slow and expensive to produce parts via TPP. In the past, the throughput challenge of TPP has been overcome by implementing a parallelized light projection technique (Saha S K et al. Science, 2019, 366(6461), 105-109; WO 2021/236907). Although parallelization successfully increased the rate of printing by a thousand times, the excessive cost of the femtosecond laser is still a major challenge for manufacturing scalability. Here, a femtosecond projection technique (Saha S K et al. Science, 2019, 366(6461), 105-109; WO 2021/236907) was modified by replacing the light source with a SLED light source that generates superluminescent light. As the cost of the SLED diode is a hundred times lower than the femtosecond laser, it significantly lowers the overall cost of printing nanoscale structures.

The projection technique with the SLED is similar to the projection technique with the femtosecond laser (Saha S K et al. Science, 2019, 366(6461), 105-109; WO 2021/236907). It is noteworthy that the SLED generates spatially coherent but temporally incoherent light and therefore it has coherence properties that are similar to that of a femtosecond laser. This advantageous coherence property of SLED light was leveraged to project thin light sheets during printing.

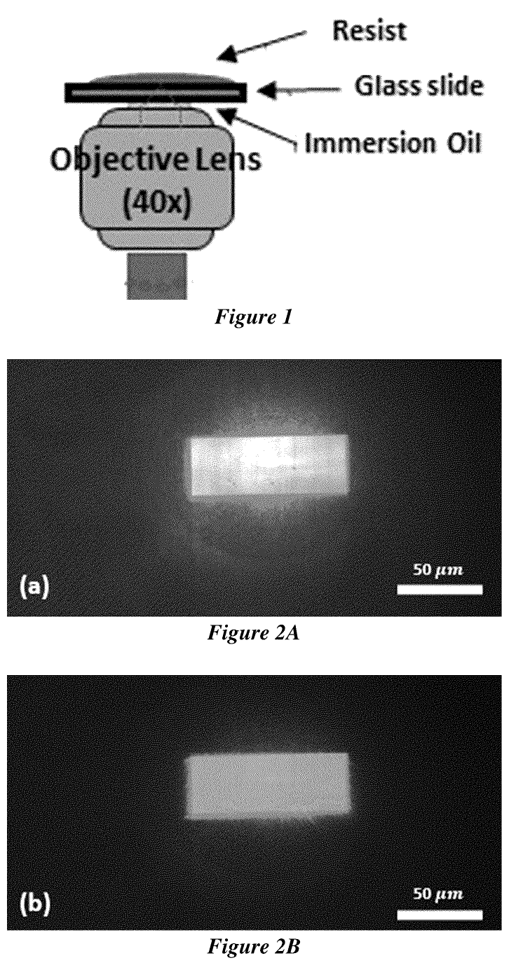

Materials and methods. A commercially available super-luminescent diode (SLD405T Thorlabs, USA) was used as the light source in the printer. The light is spatially patterned using a digital mask in the form of a digital micromirror device (DMD). A high numerical aperture (NA) oil immersion lens (40×1.3 NA) was used to focus the light into a 2D light sheet at the focal plane of the lens. The high NA ensures that a larger fraction of the oblique light is captured, and it leads to finer resolution. An upside-down projection system wherein the light first passes through the oil immersion medium and then through a thin glass cover slip was set up; the light is then focused into the photoresist material. A schematic of this upside-down set up is shown in FIG. 1.

The photoresist was prepared by combining 7-Diethylamino-3-thenoylthenoyl-coumarin (DETC) photoinitiator with pentaerythritol triacrylate (PETA) and bisphenol A ethoxylate diacrylate (BPADA) acrylic monomers. DETC has a peak absorption at 440 nm which increases single photon absorption rate at the SLED center wavelength of 405 nm. The two monomers were mixed in 35:65 ratio of PETA:BPADA to achieve a refractive index of 1.52 so that the index is matched to the index of the immersion medium of the oil objective lens. A thin layer of the photoresist was coated on top of the glass coverslip with a spin coater.

As shown in FIG. 2A-FIG. 2B, the grayscale projection technique was used to overcome the non-uniformity of light intensity distribution from the SLED. To implement the grayscale technique, a rectangular pattern of size 30 μm×80 μm was first projected on a gold-coated glass substrate and the reflected image of the pattern was then captured using a CCD camera. By using the MATLAB software, an inverse grayscale image was generated from the captured image such that when the two images are superimposed (i.e., multiplied in MATLAB) a uniform intensity distribution is achieved. For example, the grayscale technique generates a low grayscale value at the center where the intensity is high and a high grayscale value at the edges where the intensity is low. The same grayscale image is then superimposed on any subsequent image that is projected to generate the printed features.

The printed samples were developed by dipping into isopropyl alcohol (IPA) and propylene glycol methyl ether acetate (PGMEA) for 10 minutes each. The developed structures were observed through a digital microscope for quality assurance. The printed structures were then coated with a thin film of gold (<10 nm thick) and imaged on the Hitachi SU8230 scanning electron microscope (SEM).

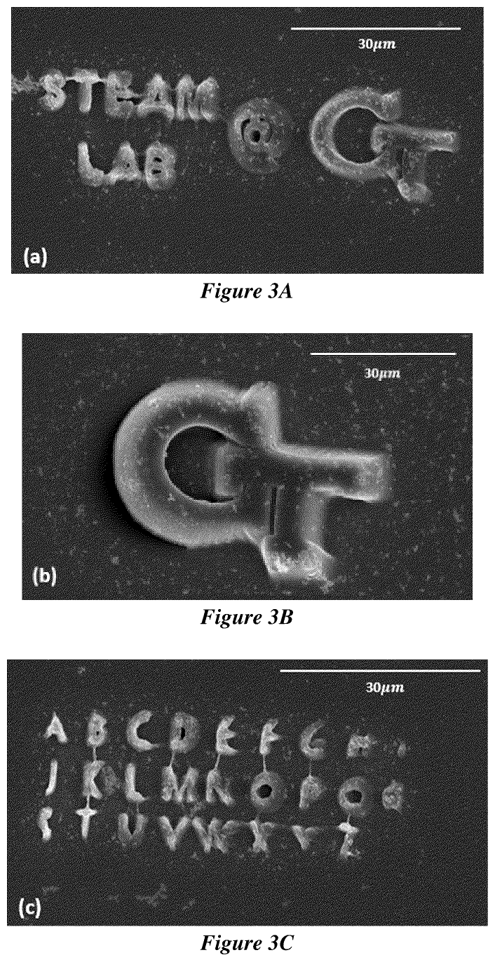

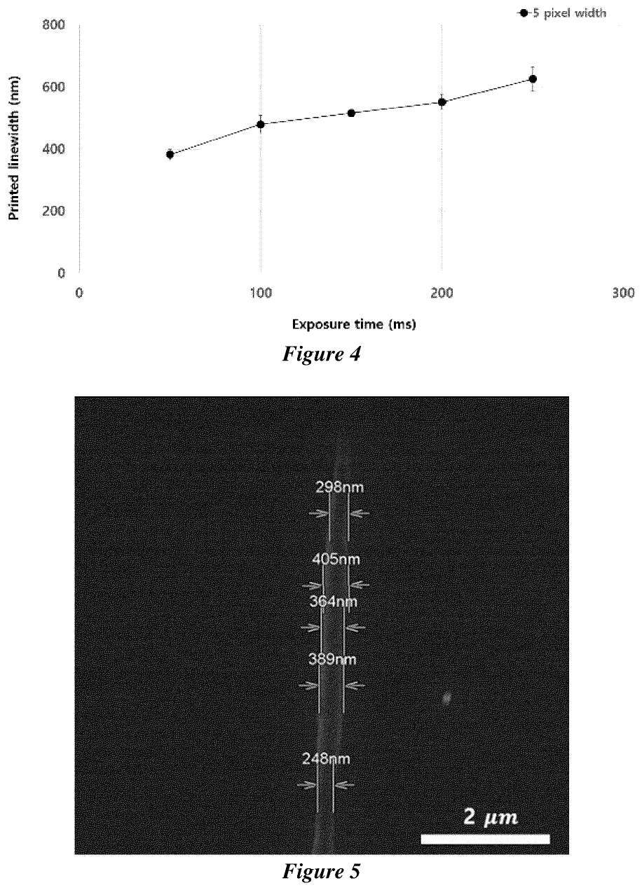

Printing performance. As shown in FIG. 3A-FIG. 3C, arbitrarily complex 2D patterns can be fabricated via the projection of SLED light. To characterize the resolution of this technique, a set of polymerization experiments were performed by varying the duration of exposure. The results of these experiments are summarized in FIG. 4. The lines were printed by projecting a 5-pixel wide line wherein each pixel is 170 nm wide in the projected image. It was observed that polymerization did not occur when lines thinner than 5 pixels were projected suggesting that the light dosage for lines thinner than 5 pixels is less than the polymerization threshold. The width of the printed lines is smaller than the projected width of the line which is 850 nm. Therefore, this printed line demonstrates the ability to generate sub-diffraction features finer than the projected light spot. The line width varies from 380 nm to 620 nm when the exposure time is varied from 50 ms to 250 ms. Moreover, lines of width as small as 248 nm can be printed with this technique (FIG. 5) by projecting 5 pixels width for 100 ms exposure time.

The diffraction limit of the system is determined by the center wavelength (λ_{center}) of the light source and the numerical aperture (NA) of the objective lens. For the combination of light source and objective lens used in this system, the diffraction limit is 380 nm. This optical diffraction limit quantifies the focal light spot size when a beam of light is focused into a single focal point. However, this optical limit does not account for the thresholding behavior of the polymerization process. Empirically, a lateral printing resolution of 250 nm was observed on the system. This observation shows that the technique can print sub-diffraction features smaller than the optical diffraction limit.

$$Diffraction limit = \frac{1.22 \times {λ}_{c e n t e r}}{N A}$$

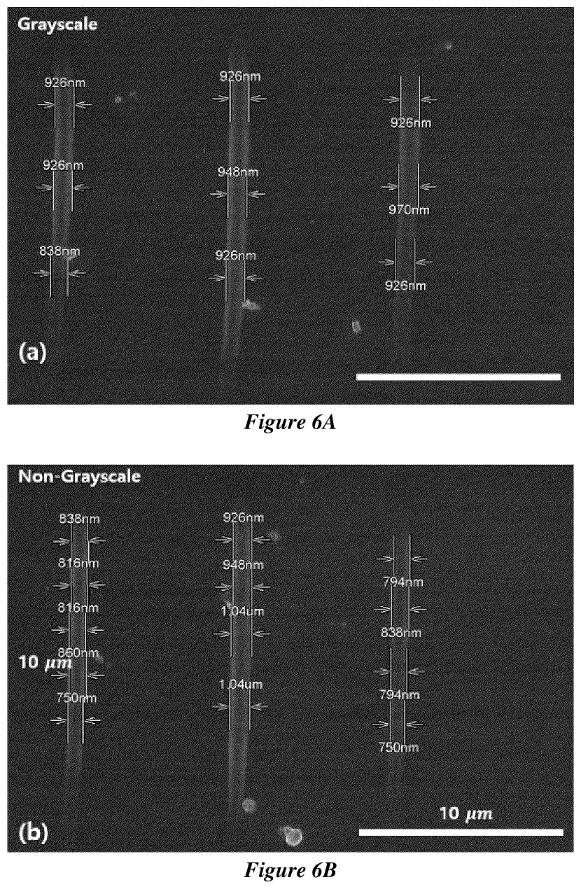

The comparison of the uniformity of printing with and without grayscale compensation is shown in FIG. 6A-FIG. 6B. Three 5-pixel wide lines were printed by using a grayscale mask and a non-grayscale mask. The variation in the width of the lines printed with grayscale compensation is smaller than in the lines printed without grayscale compensation. As shown in FIG. 6A-FIG. 6B, all three lines are close to 920 nm in width for the grayscale case while the width of the three lines varies from 750 to 1040 nm for the non-grayscale case. The average line width and the standard deviation of three lines for the grayscale case is 923 nm±36 nm while the non-grayscale value is 865 nm±112 nm. Therefore, the grayscale technique shows improvement in the precision of the structure by a factor of 3.

With the current setup, an image as large as 30 μm×80 μm can be projected and printed with exposure times of 50-250 ms. The maximum throughput corresponding to these conditions is 173 mm²/hr which is at least four times that of commercial serial TPP. Further improvement in the throughput can be achieved by increasing the optical power of the SLED light source and by optimizing the resist recipe to increase the rate of polymerization. Conclusion. Here, the printing of sub-diffraction 2D nanostructures with a low-cost light source was demonstrated. This work reduces the cost of printing submicron features by more than 100 times while achieving a sub-diffraction limit feature size resolution of 250 nm and a throughput four times that of commercial TPP. It can therefore significantly advance the scalability of light-directed nanomanufacturing for a variety of applications such as photonics, printed electronics, and optical metamaterials.

The advantage of this technique can also be applied to 3D printing aspects. To fabricate the 3D structures, multiple layers of photopolymerization are used. However, the current upside-down printing system does not allow the second layer to be polymerized on top of the first layer. This is because the first layer interferes with the second layer's light projection. Therefore, the modification of the printing system can be used to achieve the 3D structure. Moreover, the pixel width of fewer than 5 pixels cannot be polymerized with the current setup because of the dosage level of the SLED light power. A resolution smaller than 250 nm can be achieved with SLED sources of higher power. These modifications can significantly improve the scalability and affordability of sub-micron 3D printing.

### Example 3

### Scalable Printing of Metal Nanostructures Through Superluminescent Light Projection (SLP)

Abstract. Direct printing of metallic nanostructures is highly desirable, but current techniques are either unable to achieve nanoscale resolutions or are too expensive and slow. Photoreduction of solvated metal ions into metallic nanoparticles is an attractive strategy for metal printing because it is faster than deposition-based techniques. However, it is still limited by the resolution versus cost tradeoff because sub-diffraction nanostructures can be obtained today only by focusing high-intensity light from expensive femtosecond lasers. Here, this tradeoff is overcome by leveraging the spatial and temporal coherence properties of low-intensity diode-based superluminescent light. Presented herein is the superluminescent light projection (SLP) technique to rapidly print sub-diffraction nanostructures, as small as 360 nm, with light that is a billion times less intense than femtosecond lasers. Printing of arbitrarily complex 2D nanostructured silver patterns over 30 μm×80 μm areas in 500 ms time scales is demonstrated. The post-annealed nanostructures exhibit an electrical conductivity 1/18^{th} that of bulk silver. Superluminescent light projection is up to 300 times faster and 35 times less expensive than printing with femtosecond lasers. Therefore, it transforms nanoscale metal printing into a scalable format, thereby significantly enhancing the transition of nano-enabled devices from research laboratories into real-world applications.

Introduction. Nanopatterned metal thin films are key functional elements of various nano-enabled devices for applications such as electrical interconnects in high-density printed electronics, plasmonics-based sensors, photonics for solar energy conversion, quantum devices, and microelectromechanical systems. Currently, metallic nanostructures are predominantly fabricated by cleanroom-based microfabrication techniques which are prohibitively expensive for low-to-moderate volume manufacturing. Although several localized deposition-based techniques have been demonstrated for the fabrication of nanoscale metallic structures, such techniques are extremely slow with fabrication rates less than 1 μm²/s. Direct printing of micro and nano scale metal structures through localized photoreduction of solvated metal ions into metal nanoparticles is a promising alternative approach (A. Ishikawa et al. Applied physics letters 2006, 89, 113102; S. Tabrizi et al. SCIENCE CHINA Physics, Mechanics & Astronomy 2017, 60, 034201; Y. Chen et al. Nature Communications 2020, 11, 5334; E. H. Waller et al. Micromachines 2019, 10, 827; Z.-C. Ma et al. Small Methods 2018, 2, 1700413; E. J. Bjerneld et al. ChemPhysChem 2002, 3, 116). It is more affordable than cleanroom-based processes and faster than localized metal deposition techniques (L. Hirt et al. Advanced Materials 2017, 29, 1604211). This light-based printing approach has been applied to fabricate both fine nanoscale features (S. K. Saha et al. Advanced Engineering Materials 2019, 21, 1900583; S. Tabrizi et al. Advanced Optical Materials 2016, 4, 529; Y.-Y. Cao et al. Small 2009, 5, 1144; A. Ishikawa et al. Journal of Laser Micro Nanoengineering 2012, 7, 11; J. Choi et al. Manufacturing Letters 2023; E. Blasco et al. Advanced Materials 2016, 28, 3592; M. R. Lee et al. ACS applied materials & interfaces 2017, 9, 39584; B. B. Xu et al. Small 2010, 6, 1762), and relatively larger microscale features (Z. Zhao et al. Materials Today 2020, 37, 10; X. Yang et al. Advanced Functional Materials 2019, 29, 1807615; D. Wu et al. Advanced Materials 2022, 34, 2201772). However, photoreduction-based metal printing is limited by the tradeoff that exists between the resolution versus the cost and rate of printing. Consequently, it is not possible to print nanoscale metallic features with low-cost desktop printers or print them rapidly. Here, a projection-based photoreduction technique is presented that breaks this tradeoff.

A tradeoff between the resolution versus the cost and rate of printing exists in photoreduction-based metal printing because high-resolution nanoscale printing requires high-intensity light that is available from expensive femtosecond lasers. At high light intensities around 0.1-1 TW/cm², light absorption in the ink occurs via nonlinear multiphoton absorption.

This nonlinear absorption enables the printing of features that are smaller than the diffraction-limited focused light spot. For example, metallic features as small as 120 nm have been printed through localized multiphoton photoreduction (Y.-Y. Cao et al. Small 2009, 5, 1144). Various noble metals such as gold, silver, platinum, and palladium have been printed on the nanoscale via multiphoton photoreduction (S. Tabrizi et al. SCIENCE CHINA Physics, Mechanics & Astronomy 2017, 60, 034201; E. Blasco et al. Advanced Materials 2016, 28, 3592; B. B. Xu et al. Small 2010, 6, 1762; L. D. Zarzar et al. Journal of the American Chemical Society 2012, 134, 4007; L. Yang et al. Laser & Photonics Reviews 2022, 16, 2100411; T. Tanaka et al. Applied Physics Letters 2006, 88, 081107; E. H. Waller et al. Light: Advanced Manufacturing 2021, 2, 228; P. Barton et al. Nanotechnology 2017, 28, 505302). In this technique, metal nanoparticles are generated in the focal volume of a focused femtosecond laser beam through reduction of metal ions that are dissolved in an ink. Patterning is achieved by scanning the laser beam which leads to the generation of well-defined nanostructures through aggregation of the individual nanoparticles (A. Ishikawa et al. Applied physics letters 2006, 89, 113102; Y.-Y. Cao et al. Small 2009, 5, 1144; E. H. Waller et al. Light: Advanced Manufacturing 2021, 2, 228). The use of expensive femtosecond lasers leads to the high cost of printing whereas the serial scanning mechanism leads to extremely slow printing at rates of 5-20 μm²/s (A. Ishikawa et al. Applied physics letters 2006, 89, 113102; Y.-Y. Cao et al. Small 2009, 5, 1144). Multiphoton photoreduction is therefore impractical for the manufacturing of functional devices. Thus, there exists a need for a low-cost and high-throughput technique for nanoscale patterning of metal thin films.

In contrast to multiphoton photoreduction, digital light projection (DLP) is a low-cost and high-throughput technique for photoreduction-based printing of patterned metal films, but it is incapable of achieving nanoscale resolutions (Z. Zhao et al. Materials Today 2020, 37, 10; X. Yang et al. Advanced Functional Materials 2019, 29, 1807615; D. Wu et al. Advanced Materials 2022, 34, 2201772). Digital light projection relies on projection of patterned light over a large area to achieve high-throughput, whereas it relies on the use of low-intensity light from diodes to achieve photoreduction at low-costs. The underlying physical mechanism of photoreduction is similar to that in multiphoton printing with the exception that the femtosecond laser is replaced by a low-cost and low-intensity diode-based light source. For example, gold and silver metals have been printed with digital light projection at low light intensities of 10s of mW/cm² and at printing rates of 10⁴-10⁶ μm²/s (Z. Zhao et al. Materials Today 2020, 37, 10; D. Wu et al. Advanced Materials 2022, 34, 2201772). However, the fine submicron resolutions that are readily achievable with multiphoton photoreduction have not yet been demonstrated with digital light projection. Instead, the resolution of digital light projection is limited to about 5 μm (Z. Zhao et al. Materials Today 2020, 37, 10). Thus, there exists a tradeoff between the resolution versus the cost and rate in photoreduction-based printing of patterned metal films. Here, this tradeoff has been broken by applying the advantageous projection capability of low-intensity superluminescent light that is generated from low-cost superluminescent light emitting diodes (SLEDs).

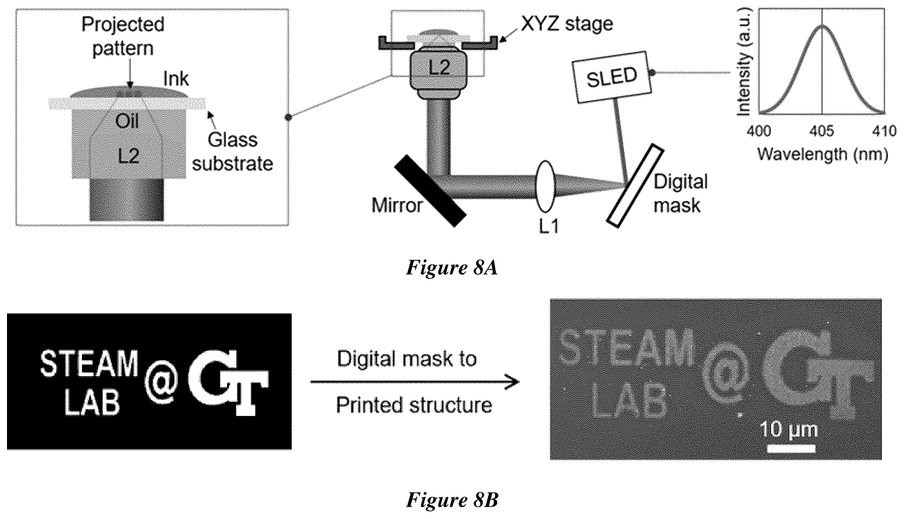

High-throughput nanoscale printing was achieved with the superluminescent light projection (SLP) technique by overcoming the scientific challenge of finely focusing light during projection of a patterned light beam. Fine nanoscale features are challenging to print with digital light projection because it is driven by spatially incoherent light. During projection of spatially incoherent light, it is challenging to achieve high contrast (i.e., high intensity gradient) at the edges of dark and bright regions (Y. Deng et al. Scientific reports 2017, 7, 1; P. S. Considine, JOSA 1966, 56, 1001). Past studies on polymerization-based lithography have elucidated that fine features smaller than the focused light spot (i.e., sub-diffraction features) can be printed with low-intensity light but it requires high intensity or dosage gradients (T. F. Scott et al. Science 2009, 324, 913). It is therefore nontrivial to achieve fine nanoscale printing with digital light projection even with those projections that contain submicron-scale focused light spots. In contrast, sharp edges can be readily achieved by projecting spatially coherent light, such as the light generated by lasers. However, lasers are undesirable for projection-based printing in digital light projection due to the generation of speckle patterns that arise due to the high temporal coherence of laser light (Y. Deng et al. Scientific reports 2017, 7, 1; J. C. Dainty, Laser speckle and related phenomena, Vol. 9, Springer science & business Media, 2013). Speckle patterns are undesirable because they can lead to uncontrolled printing in the non-illuminated regions. In contrast to lasers, low-intensity superluminescent light generated from a diode has the beneficial combination of spatial coherence and temporal incoherence. Thus, superluminescent light can generate images that have sharp edges and minimal speckle pattern. This benefit has been demonstrated in the past during holographic image generation (Y. Deng et al. Scientific reports 2017, 7, 1). In this work, the advantageous effects of superluminescent light during non-holographic projection of patterned light beams is demonstrated. This enabled achievement of affordable and high-throughput nanoscale silver printing via projection-based photoreduction, as illustrated in FIG. 8A-FIG. 8B. Here, the superluminescent light projection technique is presented and its performance for the nanoscale printing of electrically conductive silver metal is characterized.

### Results and Discussion

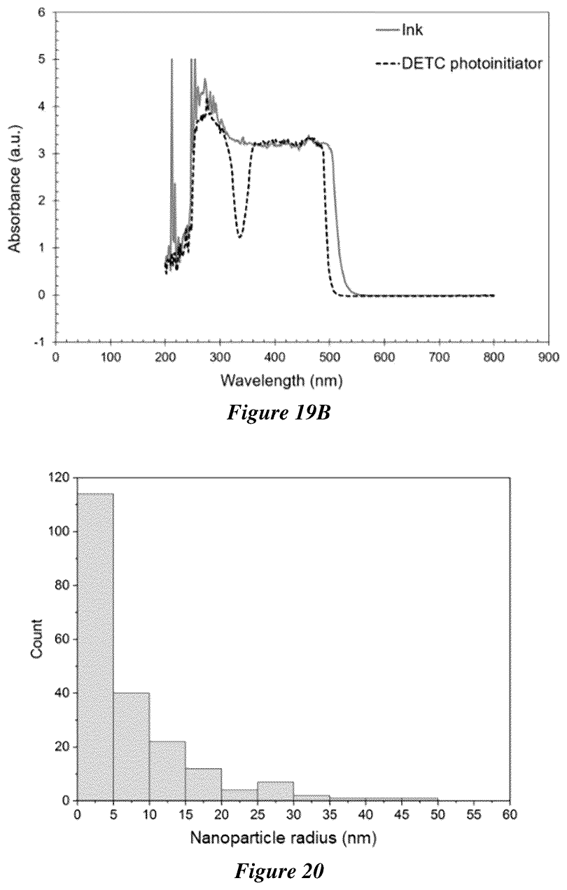

Superluminescent light projection with low-intensity light. The resolution versus cost and rate tradeoff in the printing of nanoscale metallic structures has been broken by achieving printing at light intensities that are a billion times lower than the intensities required during printing with femtosecond lasers. A schematic of a custom-built superluminescent light projection system is shown in FIG. 8A. The system comprises an upside-down printer in which patterned images are projected at the interface of the glass substrate and the ink solution. The ink comprises a solution of silver nitrate, ammonium hydroxide, trisodium citrate, and a commercially available photoinitiator in water and ethanol. A photograph of the silver ink solution is shown in FIG. 19A. Absorption spectra of the ink and the photoinitiator are shown in FIG. 19B. Details of the ink composition are provided later in the Methods section.

During printing, images are projected off of a commercially available digital micromirror device (DMD) which acts as a digital mask to pattern the light beam into dark and bright regions. Patterning is achieved by switching the individual micromirrors (i.e., pixels) on the digital micromirror device as either on or off. When a micromirror is switched on, the incident light is reflected toward the collimating lens, whereas when it is switched off the incident light is reflected out of the system. Thus, a pixelated intensity profile is generated at the digital micromirror device corresponding to the digital image that is loaded on it.

Sharply focused submicron scale light spots in the projected image were achieved by illuminating the digital micromirror device with superluminescent violet-blue light generated from a superluminescent light emitting diode. The superluminescent light emitting diode generated a continuous (i.e., non-pulsed) beam with a central wavelength of 405 nm, a 3 dB bandwidth of 4 nm and a total optical power (i.e., power over the entire wavelength spectrum) of 29 mW. A 4f-like arrangement of the collimating lens and the objective lens was set up to generate a demagnified image of the illuminated surface of the digital micromirror device on the focal plane of the objective lens, i.e., at the plane of printing. The 4f-like arrangement is further illustrated in the FIG. 13. In the printer, the pixel pitch on the digital micromirror device was demagnified to a length of 170 nm in the projected image at the plane of printing. A glass substrate was positioned on an automated X-Y-Z motion stage such that the interface between the substrate and the ink coincided with the focal plane of the objective lens. Here, a high numerical aperture (NA) oil immersion objective lens (40×1.3 NA) was used to achieve fine submicron scale diffraction-limited focused spots. The region between the lens and the substrate was filled with immersion oil to minimize spherical aberrations. In-situ optical imaging of the printing process was performed with a camera that collects the light generated by a diode after it reflects off of the substrate. The wavelength of this imaging beam (i.e., 554 nm) was selected to minimize light absorption by the ink.

The optical layout of the superluminescent light projection system is inspired by the layout in a past demonstration of projection of patterned femtosecond light sheets (S. K. Saha et al. Science 2019, 366, 105). Although light from a femtosecond laser and a superluminescent light emitting diode are fundamentally different, they are both multispectral, i.e., they both contain multiple wavelengths. In previous work, each short pulse of the femtosecond laser was temporally focused at the print plane by spectrally separating the various wavelengths of the beam at the digital micromirror device and then recombining them at the focal plane (S. K. Saha et al. Science 2019, 366, 105). Temporal focusing refers to compressing the femtosecond pulse in the time domain so that it is shortest, and therefore most intense, at the focal plane (S. K. Saha et al. Science 2019, 366, 105; E. Papagiakoumou et al. Nature Methods 2020, 17, 571). Although light from a superluminescent light emitting diode cannot be temporally focused as it is not in the form of short pulses, it can be spectrally separated and recombined because it is also composed of multiple wavelengths. Here, this similarity of the two light sources was recognized and leveraged to pattern and project the light from a superluminescent light emitting diode. In the superluminescent light projection system, the digital micromirror device acts as a diffraction grating due to its periodic micromirror pattern. Due to the multispectral nature of light from the superluminescent light emitting diode, the different wavelengths of light diffract and emerge from the digital micromirror device at slightly different angles. The 4f-like arrangement of the two lenses ensures that the various wavelengths are collected and recombined within a short region around the focal plane of the objective. The spectral separation-and-recombination generates a strong intensity gradient along the depth direction at the focal plane and the spectral coherence of the light from the superluminescent light emitting diode ensures strong intensity contrast within the focal plane.

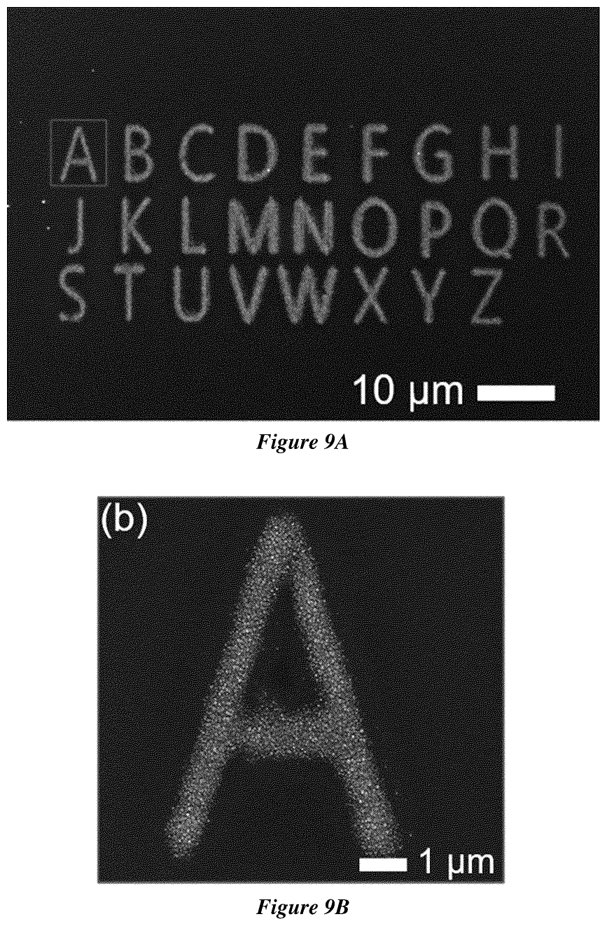

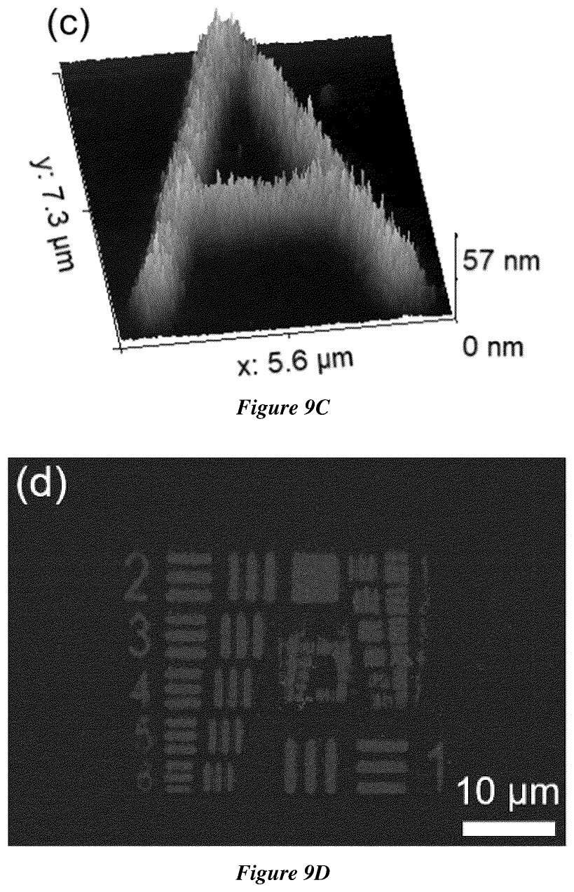

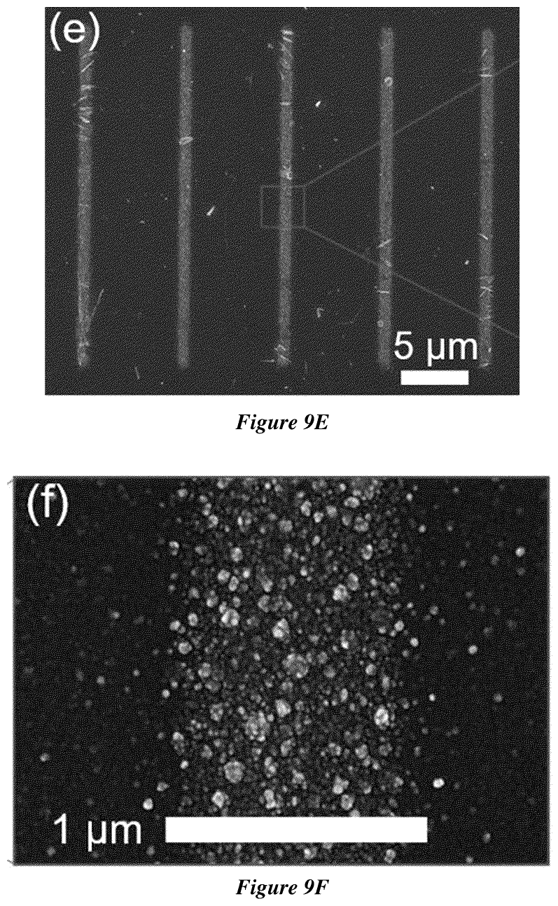

The advantageous focusing effect of superluminescent light projection was applied to print nanoscale silver structures with low-intensity light from the superluminescent light emitting diode. As illustrated in FIG. 9A-FIG. 9F, the superluminescent light projection technique is capable of patterning arbitrarily complex structures with submicron in-plane (i.e., lateral) resolutions and film thickness less than 100 nm. The individual features comprise a dense agglomerate of nanoparticles that vary in radius from 2 to 50 nm. For the structure shown in FIG. 9F, the mean radius is 7 nm, median radius is 4 nm, and the mode radius is 2 nm (the nanoparticle size distribution is shown in FIG. 20). The structures shown in FIG. 9A-FIG. 9F were printed with an optical power of 15 nW/pixel and with exposures ranging from 700 ms to 3.5 s. A first order estimate of the intensity of light can be performed by considering the approximation that the power within each pixel is uniformly distributed over the entire area of the pixel. As each pixel was demagnified to an area of 170 nm×170 nm, this power corresponds to a focused light intensity of 36 W/cm², and a fluence (i.e., energy per unit area) of 36 J/cm² for an exposure of 1 s. A more rigorous simulation of the light intensity distribution was also performed using Fourier optics techniques and the first-order estimate is within the range of intensities predicted by the rigorous simulation. The details of the first-order estimate and the Fourier optics simulation are available the Supporting Information.

When compared with femtosecond laser-based multiphoton nanoscale metal printing, the intensity in superluminescent light projection is at least 10⁹ times lower (L. Yang et al. Nature Communications 2023, 14, 1103; S. K. Saha et al. Advanced Engineering Materials 2019, 21, 1900583; S. Tabrizi et al. Advanced Optical Materials 2016, 4, 529; Y.-Y. Cao et al. Small 2009, 5, 1144; A. Ishikawa et al. Journal of Laser Micro Nanoengineering 2012, 7, 11; L. Yang et al. Laser & Photonics Reviews 2022, 16, 2100411). This drastic reduction in the light intensity is responsible for the cost-effectiveness of superluminescent light projection. In addition, thermally-induced defects, which are prevalent in multiphoton photoreduction (S. K. Saha et al. Advanced Engineering Materials 2019, 21, 1900583; S. Tabrizi et al. Advanced Optical Materials 2016, 4, 529; Y.-Y. Cao et al. Small 2009, 5, 1144; L. Yang et al. Laser & Photonics Reviews 2022, 16, 2100411) and other laser-based photoreduction (E. Greenberg et al. Advanced Materials Interfaces 2019, 6, 1900541), are absent in superluminescent light projection due to the significantly lower intensities. Thermally induced defects lead to the formation of bubbles at high intensities or exposures; therefore, these defects limit the operating regime. When compared with digital light projection-based microscale metal printing, the intensity in superluminescent light projection is a thousand times higher. However, the fluence in superluminescent light projection and digital light projection are similar because the duration of exposure in digital light projection is a thousand times longer and on the scale of tens of minutes (Z. Zhao et al. Materials Today 2020, 37, 10). This suggests that superluminescent light projection fundamentally alters the kinetics of projection-based photoreduction by trading off higher intensity for lower exposure while maintaining a constant energy input. Thus, the superluminescent light projection technique massively reduces the intensity that is required for printing of nanoscale structures via multiphoton techniques while requiring no more energy than that required during printing of microscale features via digital light projection. Thus, it enables rapid printing of metal nanostructures using a low-cost desktop printer format.

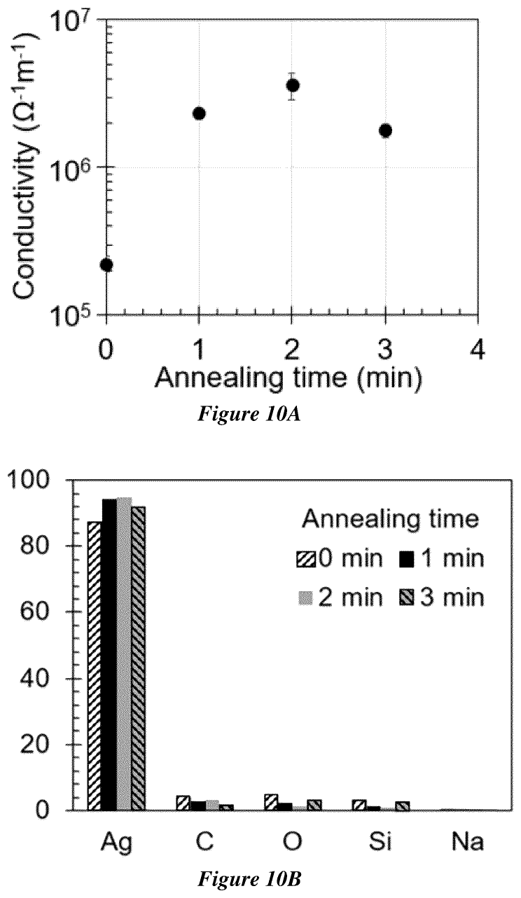

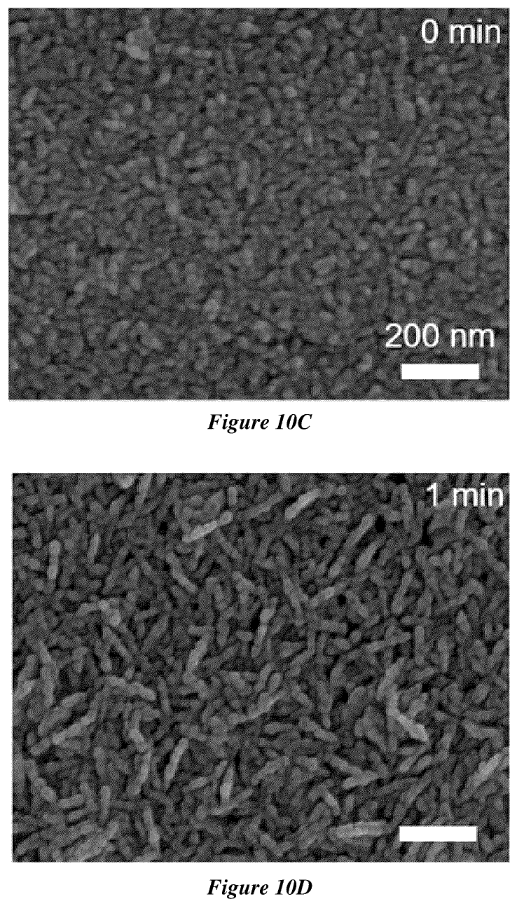

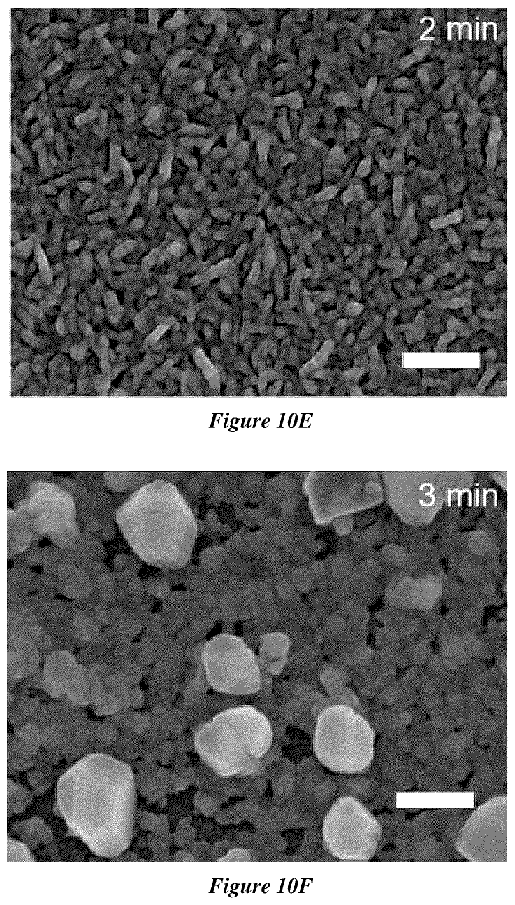

Characterization of electrical conductivity. The electrical conductivity of the printed silver structures was characterized by measuring the electrical resistance across printed nanowires that were nominally 1.25 μm wide and 20 μm long, and were measured to be on average 64 nm in height. The wires were printed to bridge the gap between two large silver pads that were themselves printed using superluminescent light projection. The conductivity of the as-printed wires was observed to be 2.2±0.3×10⁵ Ω⁻¹m⁻¹, which is about 1/300 times the conductivity of bulk silver (6.3×10⁷ Ω⁻¹m⁻¹). It was observed that the conductivity dramatically increased upon thermal annealing and a conductivity of 3.6±0.7×10⁶ Ω⁻¹m⁻¹ was achieved under optimal annealing conditions. The optimal time and temperature of annealing (i.e., 2 min at 150° C.), were identified through a series of iterative experiments. The effect of annealing time on the electrical conductivity is illustrated in FIG. 10A. The conductivity of the optimally annealed wires is 1/18 times that of bulk silver and is comparable to the conductivity of silver structures printed via multiphoton photoreduction and other printing techniques (S. Tabrizi et al. SCIENCE CHINA Physics, Mechanics & Astronomy 2017, 60, 034201; K S Bhat et al. Journal of Materials Chemistry C 2016, 4, 8522; B. Walpuski et al. Advanced Engineering Materials 2021, 23, 2001085). Therefore, these measurements demonstrate the ability to fabricate conductive metallic structures via superluminescent light projection.

Here, the thermal annealing mechanism was further investigated to clarify the source of improvement in the electrical conductivity. Through a combination of SEM imaging and Energy-dispersive X-ray (EDX) spectroscopy, it was found that the enhancement of the electrical conductivity was driven primarily by the structural changes that occur during annealing. The SEM images and the EDX spectra of the wires before annealing and after various durations of annealing are shown in FIG. 10B-FIG. 10F. As annealing progresses, the distinct nanoparticles begin to merge so that the contact area between them increases, thereby increasing the conductivity. As annealing progresses further, coarsening and dewetting of the nanoparticles occur wherein larger nanoparticles form and separate from each other and from the underlying glass substrate. This generates voids between the particles, thereby leading to a reduction in the electrical conductivity.

An explanation for the structure-based origin of the conductivity enhancement is further supported by the EDX spectra (FIG. 10B). Upon annealing, the silver concentration increases from 87% in the as-printed wires to 95% in the optimally annealed wires. Although this change in silver concentration is accompanied with a modest 1% reduction in the concentration of carbon, the majority of the compositional changes occur in the concentration of oxygen and silicon. It is hypothesized that the EDX signal from the silica in the underlying glass substrate contributes to the apparent increase in the concentration of silver during annealing. This hypothesis is supported by the observation that the concentrations of both silicon and oxygen first decrease and then increase with the duration of annealing. These changes in the elemental concentrations of silicon and oxygen correlate with the changes in the amount of void spaces in the wires, as visible in FIG. 10F. These observations verify that structural changes during annealing are primarily responsible for the conductivity enhancement and suggest that the conductivity can be further improved by optimizing the wetting behavior of the nanoparticles. Nevertheless, the structures printed here are conductive to within 1/18 th that of bulk silver and can be applied to fabricate a variety of electrically conductive micro and nanoscale devices.

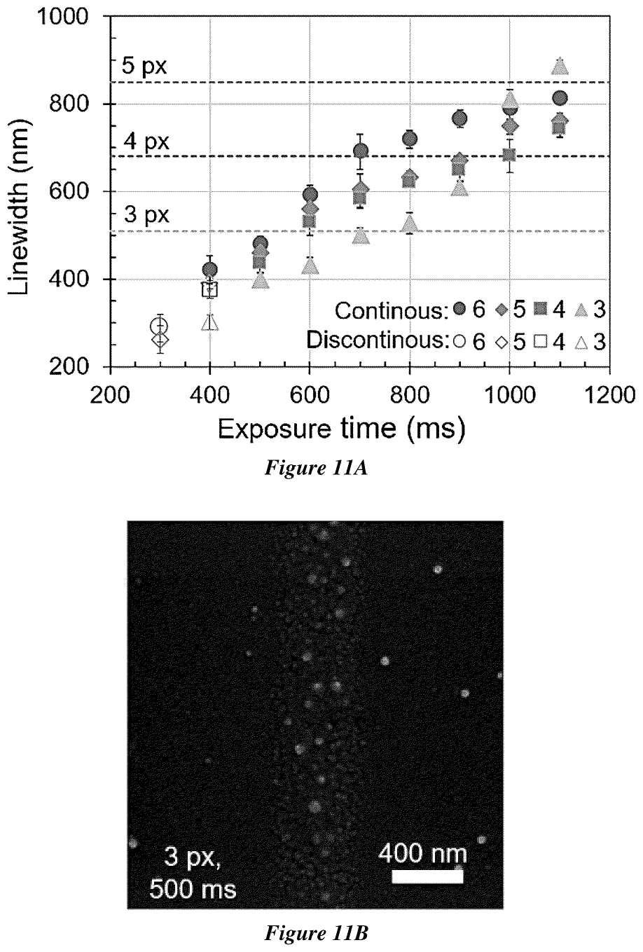

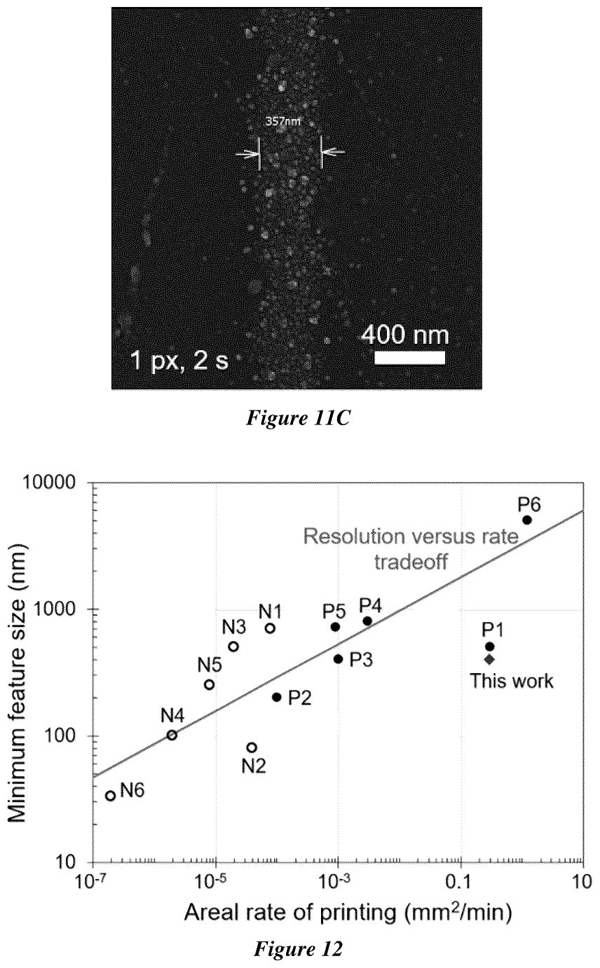

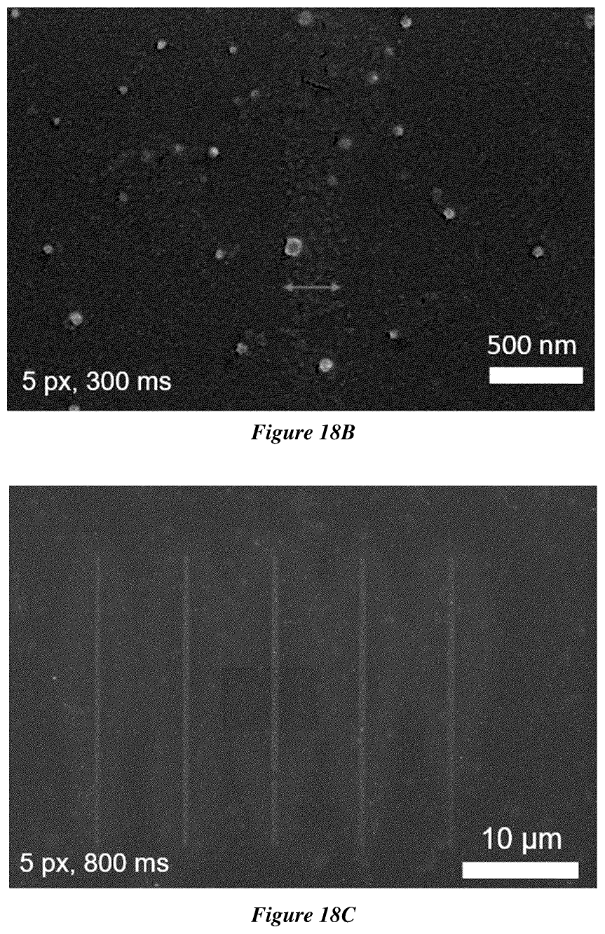

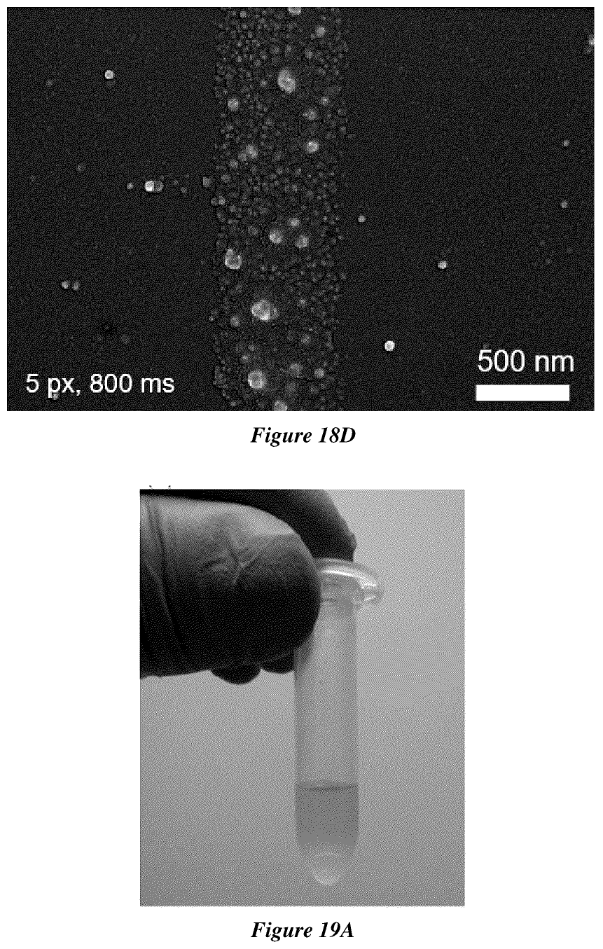

Characterization of resolution and rate. The resolution and rate of superluminescent light projection were characterized by printing benchmark periodic line patterns at various durations of exposure and projected linewidths. The experimental data is summarized in FIG. 11A-FIG. 11C. The projected patterns comprised a set of 5 lines that were 175 pixels long and were spaced regularly at a period of 50 pixels. The projected linewidth was varied from 3 to 6 pixels and the exposure time was varied from 200 to 1100 ms. The width of the printed nanowires increases with an increase in either the duration of exposure or the projected linewidth. Based on this, one may arrive at a naïve conclusion that the thinnest nanowires can be achieved with the combination of the thinnest projected linewidth and the lowest exposure. However, this reasoning was found to be faulty because metal printing with superluminescent light projection demonstrates a thresholding behavior wherein printing cannot be achieved if the duration of exposure is below a threshold value. At slightly higher exposures above the threshold, discontinuous wires are obtained wherein the density of the nanoparticles is so low that the nanoparticles do not aggregate into a continuous feature. At higher exposures, continuous nanowires with densely distributed nanoparticles are obtained. Representative SEM images of continuous and discontinuous printed nanowires are shown in FIG. 18A-FIG. 18D.

Interestingly, the threshold exposure increases to more than a second for 1- and 2-pixel wide lines but the threshold exposure is less than 500 ms for wider lines. The thinnest continuous nanowire of width 360 nm was generated by projecting a 1-pixel wide line for a relatively long duration of 2 s. Slightly wider continuous nanowires of width 400 nm were obtained by projecting 3-pixel wide lines for 500 ms. SEM images of these fine nanowires are shown in FIG. 11B and FIG. 11C. These nanowires are significantly narrower than those printed with digital light projection and are comparable in width to those printed with multiphoton photoreduction (L. Yang et al. Nature Communications 2023, 14, 1103; S. K. Saha et al. Advanced Engineering Materials 2019, 21, 1900583; A. Ishikawa et al. Journal of Laser Micro Nanoengineering 2012, 7, 11). Thus, superluminescent light projection is a high-resolution technique capable of printing nanoscale metal structures.

The resolution of printing was further characterized by comparing the widths of the printed nanowires with the characteristic length scales of the optical system. A relevant length scale is the diameter of the smallest light spot that can be obtained by focusing a laser beam of the same central wavelength (λₒ) and using the same objective lens as that present in the superluminescent light projection system. This diameter corresponds to the theoretical diffraction limit of the optical system and it is equal to 380 nm here (i.e., 1.22λₒ/NA=380 nm). Thus, the ability to print 360 nm wide nanowires demonstrates that sub-diffraction features smaller than the diffraction-limited light spot can be printed with superluminescent light projection. This is a significant advance over the state-of-art because it overturns the conventional wisdom that sub-diffraction photoreduction requires high-intensity light to activate multiphoton processing. Another relevant length scale is the nominal projected linewidth, which is the width of the lines in the demagnified image that is projected at the print plane. As each pixel on the digital micromirror device was demagnified to 170 nm on the print plane, the nominal linewidth can be obtained by multiplying the projected pixel-width of the lines by 170 nm. These nominal linewidths are represented by the horizontal dashed lines in FIG. 11A. It is noteworthy that for 3-pixel wide and wider lines, it is possible to print nanowires that are narrower than the corresponding nominal linewidth. This is in stark contrast with digital light projection-based photoreduction wherein the printed features are broader than the nominal linewidth (Z. Zhao et al. Materials Today 2020, 37, 10). Thus, superluminescent light projection is capable of printing such fine nanoscale features that are challenging to fabricate by other photoreduction techniques.

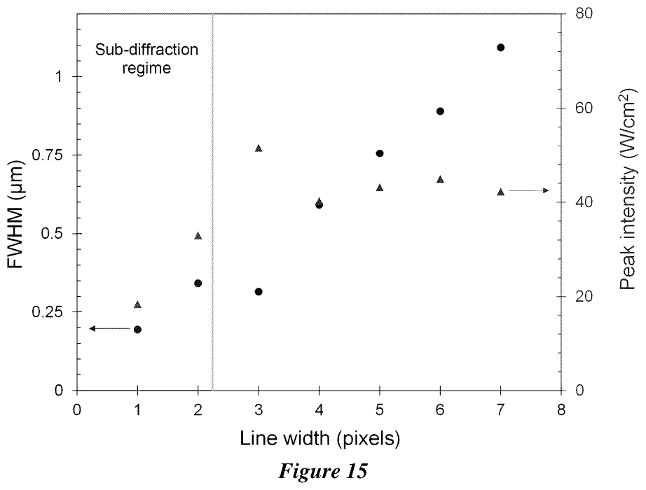

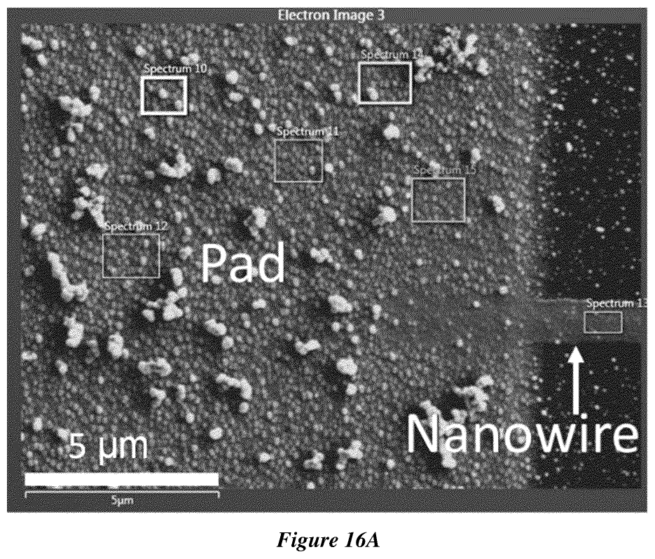

As the linewidth vs exposure behavior of 1- and 2-pixel wide lines is significantly different from those of wider lines, this behavior was investigated by computationally modeling the intensity distribution as a function of the projected linewidth. The model and the intensity vs linewidth plot (FIG. 15) are available in the Supporting Information. It was observed that the predicted intensity of the 1- and 2-pixel wide lines is approximately ⅓^{rd} and ⅔^{rd} that of 3-pixel wide lines, respectively. For lines wider than 3 pixels, the intensity does not increase any further and it stays nearly constant. This scaling of intensity with pixel linewidth suggests that the threshold exposure for 1- and 2-pixel wide lines would be significantly higher than that for wider lines. The experimental data is consistent with this expectation. An intuitive understanding for the anomalous behavior of 1- and 2-pixel wide lines can be extracted by comparing the linewidths to the optical diffraction limit. The 1- and 2-pixel wide lines are fundamentally different from thicker lines because the nominal linewidth of these thinner lines is smaller than the diffraction-limited light spot diameter (i.e., 380 nm here). The thinner lines carry less amount of light from the digital micromirror device, but the light is distributed over a relatively larger area because diffraction limits how small a focused spot can be achieved. Thus, the intensity of light is lower for these thinner linewidths. The analysis presented here enables a rational selection of light projections to achieve high-resolution and rapid printing simultaneously.

The superluminescent light projection technique is scalable to higher rates of printing than serial scanning-based techniques due to its parallel projection mechanism wherein an entire 2D plane is processed at once. The printing rate can be evaluated from the area of each projection and the duration of exposure. In this system, the area of projection is 30 μm×80 μm and the minimum duration of exposure is 500 ms. The area of projection is smaller than the theoretical limit (i.e., the beam size) because only the central region of the beam was selected for patterning; this ensures that the intensity of light over the projected area is uniform. For the rate characterization, only those printing conditions that led to the formation of continuous lines were considered. For these conditions, the areal rate of printing is 17 mm²/hr. When compared with multiphoton photoreduction techniques with comparable 400 nm feature size resolution, superluminescent light projection is about 300 times faster (A. Ishikawa et al. Journal of Laser Micro Nanoengineering 2012, 7, 11). Further improvements in rate can be readily achieved by increasing the optical power of the beam and the uniformity of the beam intensity distribution.

Comparison with other metal printing techniques. The superluminescent light projection process overcomes the traditional manufacturing tradeoff between the resolution versus the rate and cost of metal printing. The resolution versus rate tradeoff is illustrated in FIG. 12. Collectively, the existing processes demonstrate a resolution versus rate tradeoff wherein every factor of 10 improvement in the resolution is accompanied with a decrease in the rate by a factor of about 1000. The evaluation of these rate and resolution metrics is discussed in detail in the Supporting Information. For feature sizes between 100-1000 nm, multiphoton photoreduction-based techniques (P1-P5 in FIG. 12) have higher rates than other nanoscale metal patterning techniques. For comparable resolutions, multiphoton photoreduction techniques have higher rates than electrohydrodynamic inkjet printing (N1 and N2), localized electrophoresis (N3), and localized electrodeposition (N4 and N5). Outside this range, focused electron beam induced deposition techniques (N1) enable 10s of nm resolution but such techniques are incredibly slow and up to 10⁶ times slower than multiphoton techniques. On the other extreme, digital light projection-based photoreduction techniques have the highest rates (P6), but these techniques are unable to print features smaller than 1000 nm. The superluminescent light projection technique breaks the resolution versus tradeoff as it lies far off the tradeoff line. superluminescent light projection improves the resolution of digital light projection by more than a factor of 10 times while experiencing a modest decrease in the rate by a factor of 4 times. This is a modest decrease in the rate because the predicted decrease along the tradeoff line is a factor of 1000. Thus, superluminescent light projection enables both rapid and high-resolution printing of nanoscale metallic structures.

When compared with the work of other researchers, the rate of superluminescent light projection is 300 times higher than the rate of multiphoton techniques that have similar nanoscale resolution (P3) (A. Ishikawa et al. Journal of Laser Micro Nanoengineering 2012, 7, 11). When compared with past work on high-throughput multiphoton printing (P1) (S. K. Saha et al. Advanced Engineering Materials 2019, 21, 1900583), the rate of superluminescent light projection is similar. However, the overall performance of superluminescent light projection is better than the past study because it additionally overcomes the resolution versus cost tradeoff. This tradeoff becomes evident upon comparing the cost of the equipment used in the current study with the cost of the equipment used in the previous studies P1 and P6. In general, the cost of desktop printers, such as the one used in the study P6, is around 50 times less than the cost of multiphoton printers used in the study P1. However, such desktop printers are unable to print features smaller than 1000 nm. In contrast, the superluminescent light projection system costs 35 times less than the multiphoton printer used in the previous study. A cost estimate of the superluminescent light projection system is presented in the Supporting Information. The primary reason for the cost effectiveness of superluminescent light projection is the ability to perform nanoscale printing at intensities that are a billion times lower than in multiphoton techniques. Such intensities can be readily achieved by focusing superluminescent light from inexpensive diodes. Thus, this work transforms nanoscale metal printing from a slow and expensive technique into a fast and affordable technique that breaks the traditional resolution versus cost and rate tradeoff.

Conclusions. In summary, presented herein was the superluminescent light projection (SLP) technique and it was demonstrated that it can rapidly print silver nanostructures over 2D areas at once via locally patterned photoreduction. It was also demonstrated that arbitrarily complex patterns can be printed by using a digital mask. The ability to finely focus the light into nanoscale spots and to finely control the exposure time on the scale of a ms enabled sub-diffraction nanostructures and structures that are smaller than the projected light spots to be printed. Printing of features as small as 400 nm, with exposures lasting 500 ms, and over areas as large as 30 μm×80 μm in a single projection were achieved. This translates to an areal printing rate of 17 mm²/hr, which is 300 times faster than serial scanning multiphoton techniques demonstrated by other researchers. The printed nanoscale features comprise a dense distribution of silver nanoparticles that are smaller than 50 nm in radius with an average radius smaller than 10 nm. Upon thermal annealing, the nanostructures exhibit an electrical conductivity as high as 1/18^{th} that of bulk silver. As the superluminescent light projection technique enables printing nanostructures with low-intensity light that is a billion times less intense than femtosecond lasers, it is up to 35 times less expensive than multiphoton printers. Therefore, the superluminescent light projection technique breaks the traditional resolution versus cost and rate tradeoff in metal printing and transforms nanoscale patterning of metal thin films into a scalable and affordable manufacturing process. The superluminescent light projection technique can significantly improve the manufacturing of a variety of nano-enabled devices and enable their transition from research laboratories into widespread real-world use.

### Methods

Materials. Water (deionized distilled, ASTM Type II), ethanol (>99.5% purity), isopropanol (>99.5% purity), aqueous ammonium hydroxide solution (30%), anhydrous trisodium citrate, silver nitrate (>99% purity), and 7-diethylamino-3-thenoylthenoyl-coumarin (DETC) were purchased from Sigma Aldrich. All chemicals were used without any further treatment.

Ink formulation. The ink for this study was formulated based on previous work on two-photon reduction of silver (S. K. Saha et al. Advanced Engineering Materials 2019, 21, 1900583). The ink comprises a mixture of silver nitrate, ammonium hydroxide, trisodium citrate, DETC, deionized distilled water, and ethanol. Silver nitrate and an aqueous solution of ammonium hydroxide were mixed together in a stoichiometric ratio to generate diamminesilver(I) ions ([Ag(NH₃)₂]⁺). These ions act as the source of silver ions during printing. The trisodium citrate acts as a reducing agent and promotes photoreduction under low light exposure conditions. Trisodium citrate was added to the diamminesilver(I) ion solution to create a stock solution. DETC acts as the photosensitizer and it has a broad absorption spectrum that covers the incident 405 nm wavelength. DETC was dissolved in ethanol to create another stock solution Immediately before printing, the ink was generated by mixing the two stock solutions and deionized distilled water. The ink was observed to become cloudy due to precipitation of nanoparticles after about a day. However, the two stock solutions were found to be stable over several weeks. In the ink formulation used for this study, the concentration of diamminesilver(I) ions was held at 0.4 M, trisodium citrate at 0.13 M, and DETC at 0.1% by weight. Printing technique. Printing was performed on a custom-built superluminescent light projection system. The superluminescent light projection system was driven by a superluminescent light emitting diode light source (Thorlabs, SLD405T) and the digital mask was implemented using the commercially available Lightcrafter 6500 digital micromirror device. It has an array of 192033 1080 pixels at a pixel-to-pixel spacing of 7.56 μm. A commercially available tube lens of focal length 200 mm was used as the collimating lens. The beam was focused using a 40×1.3 NA oil immersion objective lens (Olympus, UPLFLN40XO). Glass coverslips of thickness 0.17 mm were used as the substrate. The coverslips were used as received from the manufacturer without any surface treatment. The substrate was mounted on the superluminescent light projection system and a drop of the ink was placed on top of the substrate. A drop of immersion oil was placed on top of the objective lens and the lens was brought close to the substrate so that the oil was sandwiched in between the lens and the substrate. The lens was focused such that the focal plane was located at the interface of the glass substrate and the ink. Digital images were loaded onto the digital micromirror device controller and patterned light was projected for a fixed duration of exposure. The exposure was finely controlled on a time scale shorter than 1 ms via the digital micromirror device controller and the optical power was held constant at 15 nW/pixel. The optical power was measured immediately before the objective lens and the lens had a measured optical transmission efficiency of 69%. After projection, the printed structures were developed by first dipping them in deionized-distilled water for 10 minutes and then dipping them in isopropanol for 10 minutes. Annealing technique. The printed structures were annealed in ambient air by placing the substrates on a hot plate. The temperature of the hot plate was held constant for a fixed duration of time. Through iterative tests, it was determined that annealing for 2 min at a temperature of 150° C. generated samples with the highest electrical conductivity.

Electrical conductivity measurements. Electrical conductivity measurements were performed via a two-point probe approach by measuring the electrical resistance across the two ends of printed nanowires. The wires were nominally 1.25 μm wide and 20 μm long and were printed with 2.5 s exposures. Large silver pads were printed at the two ends of the wire so that the probes could make electrical contact without damaging the wire. The length and width of the wires was measured from the SEM images and the height was measured from the AFM images. Three samples were measured for each annealing condition. The conductivity of the material of the wire was then evaluated using the equation for the resistance of a wire of uniform area of cross-section. Representative SEM and AFM images of the wires and the measured geometrical and electrical properties of each of the wires are available in the Supporting Information.

Optical modeling. The light intensity distribution at the focal plane was evaluated by simulating the propagation of a broadband spatially coherent beam through the optical system. The optical system comprises a 4f-like arrangement of the collimating and objective lenses wherein the surface of the digital micromirror device and the focal plane of the objective are conjugate planes of each other. The digital micromirror device is oriented to the incident beam to achieve a blazed grating condition corresponding to the central wavelength of the superluminescent light emitting diode and the digital micromirror device micromirror pitch. To simulate the intensity, the electric field for each wavelength was separately evaluated using monochromatic coherent optical models and then the contribution of each wavelength was summed up to compute the light intensity in the focal volume. Summation was performed on the intensity of each wavelength to account for the random phase relationship between the different wavelengths of the superluminescent light. Light propagation through the optical system was modeled through the following steps: (i) the digital micromirror device surface is illuminated by a uniform beam, (ii) the digital micromirror device pattern acts as an amplitude mask that modifies the field amplitude, (iii) the periodic digital micromirror device structure acts as a diffraction grating that introduces a linear wavelength-dependent phase shift, (iv) the collimating lens generates an image of the digital micromirror device plane on the back focal plane of the objective lens, and (v) the objective lens focuses this image at the glass-ink interface. These propagation steps were mathematically represented using Fourier optics and computationally modeled using the MATLAB software package.

Imaging techniques. SEM images and EDX spectra were collected on a Hitachi SU8230 system. AFM images were collected on a Bruker Icon scanning probe microscope in the tapping mode.

### Supporting Information

Evaluation of nominal intensity and fluence. The nominal intensity and fluence at any illuminated pixel on the focal plane can be evaluated by making an approximation that the power of the beam is uniformly distributed across the width of the pixel. This approximation is not very precise because the intensity is highest toward the center of a set of illuminated pixels and the intensity drops off at the edges of the pixels. However, this approximation is sufficiently accurate to estimate the order of the magnitude of the intensity. Based on this approximation, the nominal intensity (Iₙ) and the nominal fluence (Fₙ) can be represented in terms of the power per pixel (Pₚ), optical efficiency of the objective lens (ηₒ), the area of each pixel (Aₚ), and the duration of exposure (tₑ) as:

$${I}_{n} = {η}_{0} \frac{{P}_{p}}{{A}_{p}} \qquad ( S1 )$$

$${F}_{n} = {I}_{n} {t}_{e} \qquad ( S2 )$$

The nominal intensity can be evaluated by substituting the following values for the parameters in Equation S1: ηₒ=0.69, Pₚ=15 nW/pixel and Aₚ=(170 nm×170 nm)/pixel. For these parameter values, the nominal intensity at the focal plane is 36 W/cm². The nominal fluence corresponding to this intensity and tₑ=500 ms is 18 J/cm². Here, Pₚ was measured immediately before the input aperture of the objective lens.

Optical modeling of Superluminescent Light Projection (SLP). The light intensity at the focal plane of the objective lens was obtained by simulating the propagation of a flat broadband spatially coherent beam through the optical system. The optical system comprises a 4f-like arrangement of the collimating and objective lenses wherein the surface of the digital micromirror device and the focal plane of the objective are conjugate planes of each other. The digital micromirror device is oriented to the incident beam to achieve a blazed grating condition corresponding to the center wavelength of the superluminescent light emitting diode and the digital micromirror device micromirror pitch.

To simulate the intensity, the electric field and the intensity for each wavelength was first separately evaluated using monochromatic coherent optical models and then the intensity contribution of each wavelength was summed up to compute the light intensity at focal plane.

Summation was performed on the intensity of light to account for the random phase relationship between the different wavelengths of the superluminescent light.

Light propagation through the optical system was modeled through the following steps: (i) the digital micromirror device surface is illuminated by a uniform beam, (ii) the digital micromirror device pattern acts as an amplitude mask that modifies the field amplitude, (iii) the periodic digital micromirror device structure acts as a diffraction grating that introduces a linear wavelength-dependent phase shift, (iv) the collimating lens generates an image of the digital micromirror device plane on the back focal plane of the objective lens, and (v) the objective lens focuses this image at the glass-ink interface to generate the focused light sheet. These propagation steps were mathematically represented using Fourier optics and computationally modeled using the MATLAB software package. Scalar electric fields and paraxial approximations were used to simplify the optical model.

A schematic of the optical setup is shown in FIG. 13. In this system, the digital micromirror device spectrally separates the beam whereas the objective lens recombines the spectral components at the focus.

The electric field (U₀) of the light beam that is incident on the digital micromirror device surface may be represented as:

$${U}_{0} ( {x}_{d} , {y}_{d} , λ ) = {A}_{o} exp ( - \frac{{( λ - {λ}_{0} )}^{2}}{{Ω}^{2}} ) \qquad ( S3 )$$

Here, x_{d} and y_{d} are spatial coordinates on the surface of the digital micromirror device, λ is the vacuum wavelength of light, λₒ is the central wavelength, Aₒ is the peak amplitude, and 2Ω\sqrt{ln2} is the full-width-half-max (FWHM) bandwidth of the intensity versus wavelength spectrum. A Gaussian spectrum was used here based on the measured spectrum of the superluminescent diode that was provided by the manufacturer. Here, a uniform beam approximation has been made, i.e., it has been approximated that the spatial variation in the intensity of the illumination beam is negligible. This approximation is valid in the central region of the beam which was used for the studies here.

The field emerging from the digital micromirror device (U,i) is given by:

$${U}_{d} ( {x}_{d} , {y}_{d} , λ ) = {U}_{0} ( {x}_{d} , {y}_{d} , λ ) H ( {x}_{d} , {y}_{d} ) exp ( \frac{2 π i ( {x}_{d} + {y}_{d} ) sin {θ}_{m , λ}}{λ} ) \qquad ( S4 )$$

Here, θ_{m,λ} is the angle of diffraction for the wavelength λ and H is the amplitude mask that is digitally encoded on the digital micromirror device. The function H has a binary value of 0 or 1 at each spatial coordinate on the digital micromirror device surface. The phase component on the right-hand side of Equation S4 represents the linear phase due to the grating-based dispersion from the digital micromirror device. Without loss of generality, the plane of the digital micromirror device, the incident beam, and the collimating lens can be oriented such that the diffracted beam corresponding to the central wavelength (λ₀) emerges along the optical axis of the collimating lens. With such an orientation, the angle of diffraction can be represented in terms of the diffraction order (m) and the digital micromirror device grating pitch (d) as:

$$sin {θ}_{m , λ} = \frac{m}{d} ( λ - {λ}_{0} ) \qquad ( S5 )$$

By combining Equation S4 and S5, the field emerging from the digital micromirror device (U_{d}) can be represented as:

$${U}_{d} ( {x}_{d} , {y}_{d} , λ ) = {U}_{0} ( {x}_{d} , {y}_{d} , ω ) H ( {x}_{d} , {y}_{d} ) exp ( 2 π i ( {x}_{d} + {y}_{d} ) \frac{( λ - {λ}_{0} )}{λ} \frac{m}{d} ) \qquad ( S6 )$$

Light emerging from the digital micromirror device is collected by the collimating lens and then focused by the objective lens. When the digital micromirror device surface is located at the back focal plane of the collimating lens, the field at the front focal plane of the collimating lens (U_{B}) is obtained through a Fourier transform of the field at the digital micromirror device as:

$${U}_{B} ( {x}_{b} , {y}_{b} , λ ) = \frac{1}{i λ {f}_{1}} ℱ \{ {U}_{d} ( {x}_{d} , {y}_{d} , λ ) \} \qquad ( S7 )$$

Here, x_{b} and y_{b} are the spatial coordinates on the front focal plane of the collimating lens, f₁ is the focal length of the collimating lens, i=√−1 and [symbol] is the Fourier transform operator. The field propagating into the back aperture of the objective lens (U_{A}) is limited by the pupil function (P) of the objective as:

U_{A}(x_{b}, y_{b}, λ)=U_{B}(x_{b}, y_{b}, λ)P(x_{b}, y_{b}) (S8)

The pupil function depends on the diameter of the circular back aperture of the objective lens (D_{obj}) and is given by:

$$P ( {x}_{b} , {y}_{b} ) = \{ \begin{matrix}1 for & \vert \sqrt{{x}_{b}^{2} + {y}_{b}^{2}} \vert < 0.5 {D}_{o b j} \\ 0.5 for & \vert \sqrt{{x}_{b}^{2} + {y}_{b}^{2}} \vert = 0.5 {D}_{o b j} \\ 0 for & \vert \sqrt{{x}_{b}^{2} + {y}_{b}^{2}} \vert > 0.5 {D}_{o b j}\end{matrix} \qquad ( S9 )$$

The field at the front focal plane of the objective lens (U_{f}) is obtained as a Fourier transform of the field at the back focal plane of the objectives lens as:

$${U}_{f} ( {x}_{f} , {y}_{f} , λ ) = \frac{1}{i λ {f}_{2}} ℱ \{ {U}_{A} ( {x}_{b} , {y}_{b} , λ ) \} \qquad ( S10 )$$

Here, f₂ is the focal length of the objective lens. The lateral coordinates (x_{f}, y_{f}) are related to the spatial coordinates on the digital micromirror device surface through the optical magnification of the system (M=f₂/f₁) as:

x_{f}=Mx_{d} (S11)

y_{f}=My_{d} (S12)

The intensity at the focal plane corresponding to each wavelength (I_{λ}) is obtained as:

I_{λ}(x_{f}, y_{f}, λ)=|U_{f}(x_{f}, y_{f}, λ)|² (S13)

Finally, the total intensity I_{T} at the focal plane arising from all the wavelengths is obtained by summing up the intensity for the individual wavelengths as:

I_{T}(x_{f}, y_{f})=∫_{-∞}^{∞}I_{λ}(x_{f}, y_{f}, λ)dλ (S14)

For an arbitrary real positive value of Aₒ, Equations S3-S14 are sufficient to evaluate the FWHM lateral resolution during focusing. To accurately quantify the absolute value of the intensity in units of W/cm², λ₀ is obtained using energy conservation as:

$${A}_{0} = {[ \sqrt{\frac{1}{π}} \frac{{η}_{o} {P}_{b}}{Ω {A}_{b}} ]}^{0.5} \qquad ( S15 )$$

Here, ηₒ is the optical efficiency of the objective lens, P_{b} is the optical power of the beam measured at the aperture of the objective lens, and A_{b} is the area of the beam as it emerges from the digital micromirror device surface.

Computational model in MATLAB. The computational model was set up in MATLAB by numerically representing Equations S3-S15. The numerical values of the parameters of the optical model are listed in Table 1. A grid of 256×256 pixels was used to simulate the digital micromirror device structure. In this grid representation, each pixel represents a single micromirror. The pixel spacing in this grid was set equal to the physical micro-mirror spacing of the digital micromirror device (i.e., equal to 7.56 μm). MATLAB's built-in ‘fft2()’ function was used to numerically implement the Fourier transform operators.

TABLE 1
Numerical values of parameters in the optical model

| Parameter | Numerical value | Units |
|---|---|---|
| λₒ | 405 | nm |
| Ω | 2.4 | nm |
| m | 8 | Non-dimensional |
| d | 7.56 | μm |
| f₁ | 200 | mm |
| f₂ | 4.5 | mm |
| D_{obj} | 7.7 | mm |
| M | 0.0225 | Non-dimensional |
| P_{b} | 1.23 | mW |
| A_{b} | 4.67 | mm² |
| NA | 1.3 | Non-dimensional |
| ηₒ | 0.69 | Non-dimensional |
| Aₒ | 0.065 | √(W/cm²-nm) |

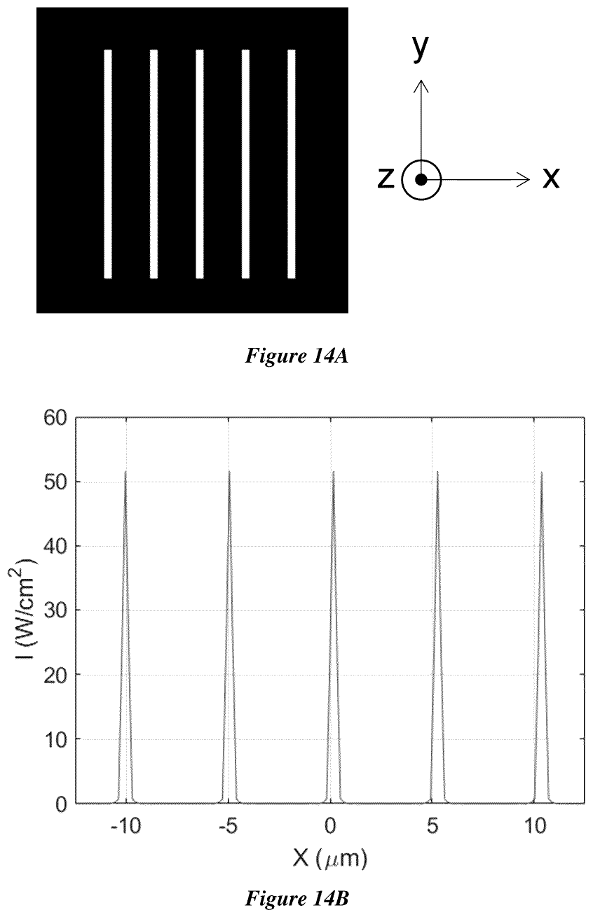

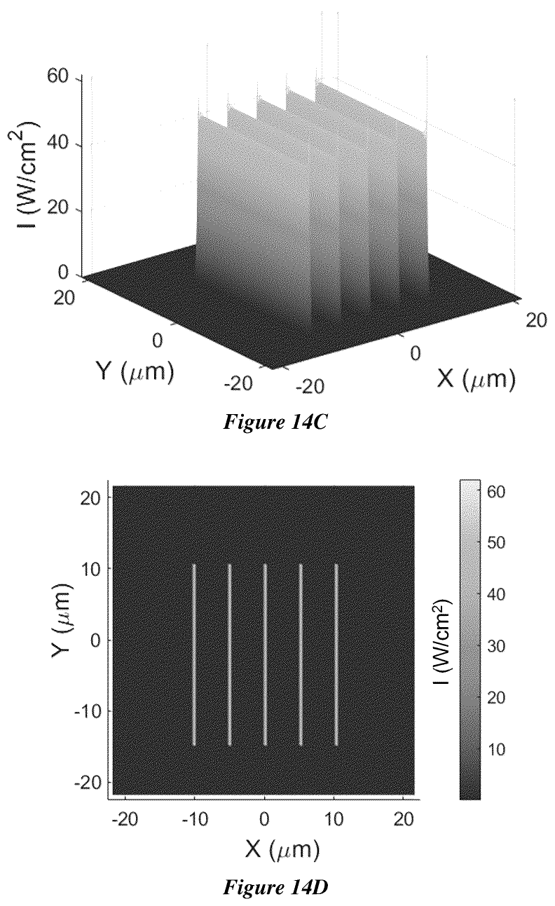

The simulated intensity distribution, peak intensity and the full-width half-max (FWHM) size of the beam at the focal plane are shown in FIG. 14A-FIG. 14D and FIG. 15. The intensity is higher at the center and lower at the edges of the lines. The peak intensity lies in the range of 18-52 W/cm² depending on the width of the projected lines. The nominal intensity that was evaluated in above (i.e., 36 W/cm²) lies within this range. The sub-diffraction regime in FIG. 15 refers to the linewidths that are smaller than the theoretical diffraction-limited beam diameter that one would obtain by focusing a Gaussian light beam into a single spot. This beam diameter is equal to 380 nm and was obtained from the numerical aperture of the objective lens (NA) as:

$${D}_{d} = 1.22 \frac{{λ}_{o}}{N A} \qquad ( S16 )$$

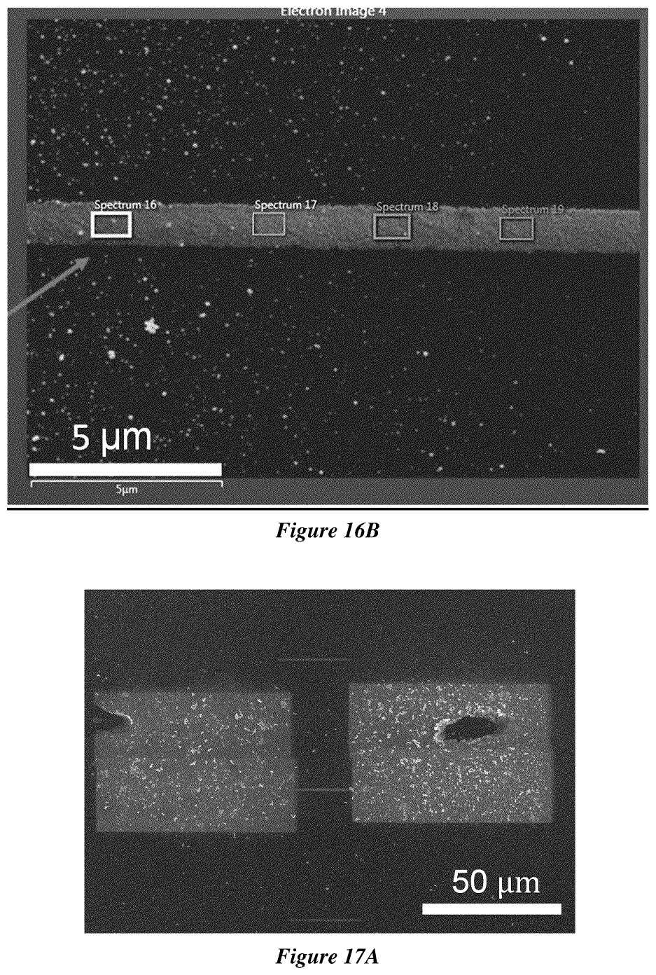

Energy-dispersive X-ray spectroscopy (EDS) data. EDS analysis was performed on printed samples before and after thermal annealing. EDS was performed on the Hitachi SU8230 scanning electron microscope (SEM) which is equipped with an energy-dispersive X-ray spectroscope. The compositions before and after annealing are listed in Table 2. The EDS spectra were measured at five different locations for each condition and the average weight percentage and the standard deviation (G) values listed in the table represent the average and standard deviation from these five data points. Representative SEM images illustrating the locations at which the EDS spectra were measured are shown in FIG. 16A-FIG. 16B.

TABLE 2
Elemental weight percentage of the printed nanowire before and after annealing.

| | | Before annealing | | After 1 min anneal | | After 2 min anneal | | After 3 min anneal | |
|---|---|---|---|---|---|---|---|---|---|
| | | Weight | σ | Weight | σ | Weight | σ | Weight | σ |
| # | Element | (%) | (%) | (%) | (%) | (%) | (%) | (%) | (%) |
| 1 | Ag | 87.3 | 1.3 | 94.0 | 0.5 | 94.9 | 0.6 | 92.3 | 3.1 |
| 2 | C | 4.1 | 0.4 | 2.3 | 0.2 | 3.1 | 0.4 | 1.5 | 0.7 |
| 3 | O | 5.0 | 0.7 | 2.2 | 0.1 | 1.2 | 0.2 | 3.4 | 1.7 |
| 4 | Si | 3.2 | 0.4 | 1.4 | 0.2 | 0.8 | 0.2 | 2.6 | 1.4 |
| 5 | Na | 0.5 | 0.3 | 0.1 | 0.2 | 0.0 | 0.0 | 0.3 | 0.4 |

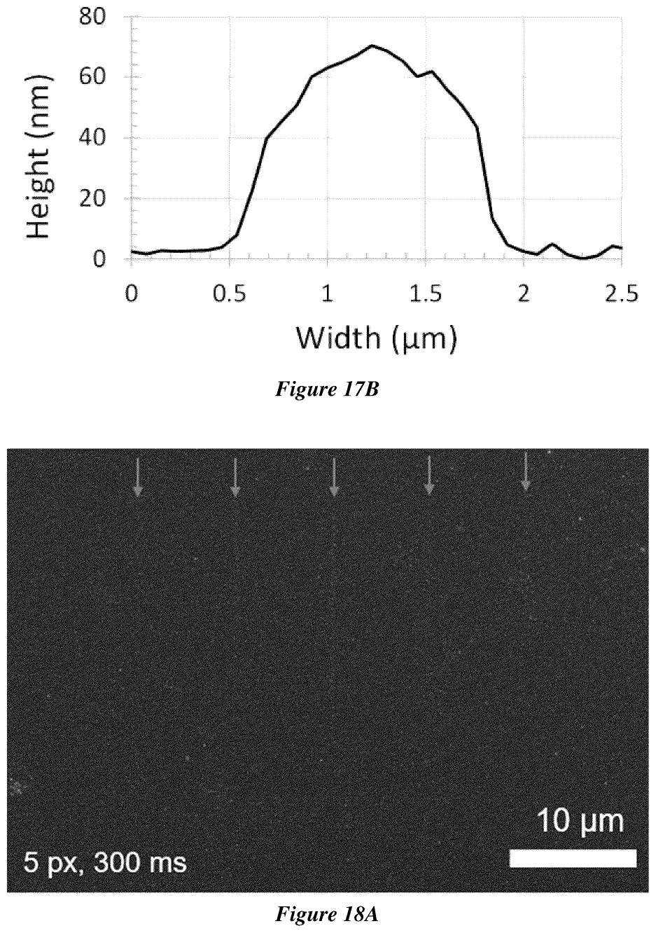

Characterization of electrical conductivity. Representative SEM and atomic force microscope (AFM) images of the structures that were printed to measure the electrical conductivity of the printed nanowires are shown in FIG. 17A-FIG. 17B. The measured geometrical parameters, i.e., length (L), width (W), height (H), and the electrical parameters, i.e., resistance (R) and electrical conductivity of the nanowires are listed in Table 3. The electrical conductivity σₑ was evaluated from the measured parameters as:

$${σ}_{e} = \frac{L}{R \cdot W \cdot H} \qquad ( S17 )$$

TABLE 3
Measured geometrical and electrical
parameters of the printed nanowires.

| | Anneal | | | | | |
|---|---|---|---|---|---|---|
| | time | L | W | H | R | σₑ |
| # | (min) | (μm) | (μm) | (nm) | (Ω) | (Ω⁻¹m⁻¹) |
| 1 | 0 | 21.4 | 1.25 | 66 | 1300 | 2.0 × 10⁵ |
| 2 | 0 | 22.3 | 1.20 | 57 | 1300 | 2.5 × 10⁵ |
| 3 | 0 | 21.5 | 1.30 | 56 | 1400 | 2.1 × 10⁵ |
| 4 | 1 | 20.6 | 1.50 | 66 | 94 | 2.3 × 10⁶ |
| 5 | 1 | 21.4 | 1.40 | 62 | 97 | 2.5 × 10⁶ |
| 6 | 1 | 21.9 | 1.50 | 67 | 100 | 2.2 × 10⁶ |
| 7 | 2 | 18.5 | 1.54 | 66 | 62 | 3.0 × 10⁶ |
| 8 | 2 | 22.0 | 1.61 | 67 | 58 | 3.5 × 10⁶ |
| 9 | 2 | 20.2 | 1.60 | 65 | 44 | 4.4 × 10⁶ |
| 10 | 3 | 21.7 | 1.70 | 64 | 120 | 1.7 × 10⁶ |
| 11 | 3 | 22.7 | 1.52 | 63 | 118 | 2.0 × 10⁶ |
| 12 | 3 | 22.1 | 1.55 | 65 | 129 | 1.7 × 10⁶ |

Rate and resolution comparisons with literature. The rate of printing and the resolution of printing (i.e., the minimum size of the printed features) for this study and past studies are listed in Table 4. The areal printing rate (Rₛ) of a serial printing process can be obtained from the scanning speed (V) and the feature width (w) as:

Rₛ=wV (S18)

For parallelization approaches that scan multiple focal spots at once, the areal rate can be evaluated by multiplying the rate for a single beam (Equation S18) by the total number of foci. The areal printing rate of the parallel projection processes Rₚ can be obtained from the duration of the light exposure (tₑ) and the area of projection (Aₚᵣ) as:

$${R}_{p} = \frac{{A}_{p r}}{{t}_{e}} \qquad ( S19 )$$

TABLE 4
Minimum feature size and areal rate of metal printing for this and past studies.

| | | Processing | Printing | W | V | | | | Areal rate |
|---|---|---|---|---|---|---|---|---|---|
| # | Reference* | mechanism | modality | (nm) | (mm/s) | Aₚᵣ | tₑ | | (mm²/min) |
| A | This work | Photoreduction | Projection, SLP | 400 | — | 30 × 80 | 0.5 | s | 0.29 |
| | | | | | | μm² | | | |
| B | This work | Photoreduction | Projection, SLP | 360 | — | 30 × 80 | 2 | s | 0.07 |
| | | | | | | μm² | | | |
| P1 | Saha et al., 2019 | Photoreduction | Serial | 500 | 10 | — | — | | 0.3 |
| P2 | Tabrizi et al., 2016 | Photoreduction | Serial | 200 | 0.01 | — | — | | 1 × 10⁻⁴ |
| P3 | Ishikawa et al., 2012 | Photoreduction | Serial | 400 | 0.05 | — | — | | 1 × 10⁻³ |
| P4 | Qian et al., 2018 | Photoreduction | Multi-foci | 800 | 0.01 | — | — | | 3 × 10⁻³ |
| | | | serial scan | | | | | | |
| | | | (7 foci) | | | | | | |
| P5 | Yang et al., 2023 | Photoreduction | Serial | 720 | 0.02 | — | — | | 9 × 10⁻⁴ |
| P6 | Zhao et al., 2020 | Photoreduction | Projection, DLP | 5000 | — | 3.5 × 3.5 | 10 | min | 1.2 |
| | | | | | | mm² | | | |
| P7 | Yang et al., 2019 | Photoreduction | Projection, DLP | 15000 | — | 2 × 3 | 15 | min | 40 |
| | | | | | | cm² | | | |

| | | | | | | | | |
|---|---|---|---|---|---|---|---|---|
| N1 | An et al., 2015 | Electrohydrodynamic- | Serial | 700 | 0.002 | — | — | 8 × 10⁻⁵ |
| | | inkjet printing | | | | | | |
| N2 | Schneider et al., 2016 | Electrohydrodynamic- | Serial | 80 | 0.01 | — | — | 4 × 10⁻⁵ |
| | | inkjet printing | | | | | | |
| N3 | Takai et al., 2014 | Localized | Serial | 500 | 7 × 10⁻⁴ | — | — | 2 × 10⁻⁵ |
| | | electrophoresis | | | | | | |
| N4 | Hu et al., 2010 | Meniscus-confined | Serial | 100 | 3 × 10⁻⁴ | — | — | 2 × 10⁻⁶ |
| | | electrodeposition | | | | | | |
| N5 | Hirt et al., 2016 | Localized | Serial | 250 | 5 × 10⁻⁴ | — | — | 8 × 10⁻⁶ |
| | | electrodeposition | | | | | | |
| N6 | Winkler et al., 2018 | Focused electron | Serial | 33 | 9 × 10⁻⁵ | — | — | 2 × 10⁻⁷ |
| | | beam induced | | | | | | |
| | | deposition | | | | | | |

*S. K. Saha et al. Advanced Engineering Materials 2019, 21, 1900583; S. Tabrizi et al. Advanced Optical Materials 2016, 4, 529; A. Ishikawa et al. Journal of Laser Micro Nanoengineering 2012, 7, 11; D. Qian et al. Optics letters 2018, 43, 5335; L. Yang et al. Nature Communications 2023, 14, 1103; Z. Zhao et al. Materials Today 2020, 37, 10; X. Yang et al. Advanced Functional Materials 2019, 29, 1807615; B. W. An et al. Advanced Materials 2015, 27, 4322; J. Schneider et al. Advanced Functional Materials 2016, 26, 833; T. Takai et al. Opt. Express 2014, 22, 28109; J. Hu et al. Science 2010, 329, 313; L. Hirt et al. Advanced Materials 2016, 28, 2311; R. Winkler et al. ACS Applied Nano Materials 2018, 1, 1014

Cost-effectiveness of superluminescent light projection. The light source in the superluminescent light projection system costs $5300. In contrast, the femtosecond light source for a serial scanning multi-photon lithography system costs ˜$50,000. Thus, the light source for superluminescent light projection is about 10 times less expensive. This cost-effectiveness further improves to a factor of 35 times when the cost of the entire printer is considered. For example, commercial multi-photon systems cost ˜$500,000, whereas the cost of the custom-built superluminescent light projection system is ˜$14,000. The cost of the individual components of the superluminescent light projection system are summarized in Table 5. Thus, superluminescent light projection significantly lowers the barrier to access nanoscale printing of metals via affordable printers.

TABLE 5
Cost of the custom-built superluminescent light projection system.

| # | Functional element | Cost ($) |
|---|---|---|
| 1 | Light source | 5300 |
| 2 | Digital mask | 2070 |
| 3 | Motion system | 2780 |
| 4 | Optical elements | 3750 |

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions, devices, and methods of the appended claims are not limited in scope by the specific compositions, devices, and methods described herein, which are intended as 5 illustrations of a few aspects of the claims and any methods that are functionally equivalent are intended to fall within the scope of the claims. Various modifications of the compositions, devices, and methods in addition to those shown and described herein are intended to fall within the scope of the appended claims. Further, while only certain representative composition elements, system elements, and method steps disclosed herein are specifically described, other 10 combinations of the composition elements, device elements, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed:

1. A system for printing with superluminescent light, the system comprising:
a light source for generating superluminescent light comprising a plurality of wavelengths, with the proviso that the light source is not a femtosecond laser;
a tunable mask for receiving the superluminescent light, wherein the tunable mask comprises a dispersive element;
the tunable mask being configured to receive the superluminescent light from the light source and spatially separate the plurality of wavelengths thereby splitting the superluminescent light into a plurality of light components, each of the plurality of light components comprising a portion of the plurality of wavelengths; and
an optical assembly configured to collimate the plurality of light components to create a collimated beam and to focus the collimated beam into a focused beam which is projected at an image plane onto or within a sample comprising a photosensitive material,
such that the focused beam simultaneously illuminates a selected portion of the photosensitive material within a layer of the sample corresponding to a selected pattern, thereby causing a simultaneous photoreaction that prints structures in the selected pattern.

2. The system of claim 1, wherein the superluminescent light generated by the light source is spatially coherent and temporally incoherent.

3. The system of claim 1, wherein an instantaneous optical intensity of a focused beam of the superluminescent light does not exceed 1000 W/cm².

4. The system of claim 1, wherein the light source comprises a superluminescent light emitting diode (SLED).

5. The system of claim 1, wherein the tunable mask comprises a digital micromirror device.

6. The system of claim 1, further comprising a controller operably coupled to the tunable mask.

7. The system of claim 1, wherein the optical assembly comprises a collimating lens and an objective lens, wherein the collimating lens is configured to collimate the plurality of light components to create a collimated beam and the objective lens is configured to focus the collimated beam into a focused beam, and wherein a distance between the tunable mask and the collimating lens is equal to a focal length of the collimating lens.

8. The system of claim 1, wherein the structures comprise a polymer, a metal, or a combination thereof.

9. The system of claim 1, wherein the system has a printing resolution (in plane) of from 100 nanometers to 100 micrometers.

10. The system of claim 1, wherein the system is configured to simultaneously illuminate the selected portion for an amount of time of from 1 millisecond to 10 minutes.

11. The system of claim 1, wherein the system is an additive manufacturing system configured to print 3D structures on a layer-by-layer basis.

12. A method of use of the system of claim 1, the method comprising using the system to print the structures.

13. A method of printing with superluminescent light, the method comprising:
generating a patterned light sheet from superluminescent light, with the proviso that the superluminescent light is not generated by a femtosecond laser; and
projecting the patterned light sheet at an image plane onto or within a sample comprising a photosensitive material;
thereby simultaneously illuminating a selected portion of the photosensitive material within a layer of the sample corresponding to a selected pattern, thereby causing a simultaneous photoreaction that prints structures in the selected pattern.

14. The method of claim 13, wherein generating the patterned light sheet comprises:
generating superluminescent light comprising a plurality of wavelengths, with the proviso that the superluminescent light is not generated by a femtosecond laser;
directing the superluminescent light at a tunable mask, wherein the tunable mask comprises a dispersive element;
wherein the tunable mask spatially separates the plurality of wavelengths thereby splitting the superluminescent light into a plurality of light components, each of the plurality of light components comprising a portion of the plurality of wavelengths; and
directing at least a portion of the plurality of light components towards an optical assembly configured to collimate the plurality of light components to create a collimated beam and to focus the collimated beam into a focused beam which is projected at an image plane onto or within the sample as the patterned light sheet.

15. The method of claim 14, further comprising:
receiving, by a processor, a first image having a plurality of pixels corresponding to the selected pattern;
directing, by the processor, the generation of the superluminescent light; and
directing, by the processor, based on the first image, the tunable mask to generate the patterned light sheet according to the selected pattern.

16. The method of claim 13, further comprising:
supporting the sample on a motion stage; and
controllably translocating the motion stage to thereby generate a continuous structure.

17. The method of claim 13, wherein the selected portion is illuminated for an amount of time of from 1 millisecond to 10 minutes.

18. The method of claim 13, further comprising developing the structure by exposure to a solvent.

19. The method of claim 13, wherein the structures comprise a metal and the method further comprises sintering and/or annealing the printed metal structures.

20. The method of claim 13, wherein the method has a printing resolution (in plane) of from 100 nanometers to 100 micrometers.
